(19) United States
(12) Patent Application Publication
(10) Pub. No.: US 2018/0288306 A1
(43) Pub. Date: Oct. 4, 2018

(54) MASK-LESS PHASE DETECTION AUTOFOCUS

(71) Applicant: QUALCOMM Incorporated, San Diego, CA (US)

(72) Inventors: Robert Francis Lay, San Diego, CA (US); Micha Galor Gluskin, San Diego, CA (US)

(21) Appl. No.: 15/474,771

(22) Filed: Mar. 30, 2017

(51) Int. Cl. H04N 5/232

(52) U.S. Cl. CPC H04N 5/23212

(57) ABSTRACT

Devices and methods are disclosed for phase detection autofocus. In one aspect, an image capture device includes an image sensor, diodes, filter array, single-diode microlenses, multi-pixel-microlens, and an image signal processor. Each filter of the array positioned within proximity of one of the diodes and configured to pass light to the diode. Each single-diode microlens positioned within proximity of one of the filters. Each multi-pixel-microlens positioned within proximity of three adjacent filters. Two of the three filters may be configured to pass the same wavelengths of light to first and second diodes. One of the three filters may be disposed between the two filters and configured to pass different wavelengths of light to a third diode. The first and second diodes collect light incident in a first and second direction, respectively. The image signal processor performs phase detection autofocus based on values received from the first and second diodes.

### TECHNICAL FIELD

The systems and methods disclosed herein are directed to phase detection autofocus, and, more particularly, to mask-less phase detection autofocus sensors and processing techniques.

### BACKGROUND

Some image capture devices use phase difference detection sensors (which may also be referred to as “pixels”) to perform autofocus. On-sensor phase difference detection works by interspersing phase difference detection pixels between imaging pixels, typically arranged in repeating sparse patterns of left and right pixels. The system detects phase differences between signals generated by different phase difference detection pixels, for example between a left pixel and a nearby right pixel. The detected phase differences can be used to perform autofocus, for example, the detected phase differences can be used to calculate depth in a scene to assist autofocus.

Phase detection autofocus operates faster than contrast-based autofocus, however some implementations place a metal mask or other structures over the image sensor to create left and right phase detection pixels, resulting in less light reaching the masked pixels. Typical imaging sensors have a microlens formed over each individual pixel to focus light onto each pixel, and the phase detection autofocus mask placed over the microlenses reduces the light entering the microlens of a phase detection pixel by about 50%. Because the output of phase detection pixels has lower brightness than the output of normal image capturing pixels, the phase difference detection pixels create noticeable artifacts in captured images that require correction. By placing the phase detection pixels individually amidst imaging pixels, the system can interpolate values for the phase detection pixels.

Phase detection pixels are used in pairs. When the scene is out of focus, the phase detection pixel phase shifts the incoming light slightly. The distance between phase detection pixels, combined with their relative shifts, can be convolved to give a determination of how far an optical assembly of an imaging device needs to move a lens to bring the scene into focus.

### SUMMARY

A summary of sample aspects of the disclosure follows. For convenience, one or more aspects of the disclosure may be referred to herein simply as “some aspects.”

Methods and apparatuses or devices being disclosed herein each have several aspects, no single one of which is solely responsible for its desirable attributes. Without limiting the scope of this disclosure, for example, as expressed by the claims which follow, its more prominent features will now be discussed briefly.

One aspect of the present disclosure provides an image capture device. The image capture device may include an image sensor, multiple diodes, a color filter array, multiple single-diode microlenses, multiple multi-pixel-microlenses, and an image signal processor. The multiple diodes may be configured to sense light from a target. The color filter array may be arranged in a pattern, where each color filter may be positioned within proximity of one of the multiple diodes and configured to pass one or more wavelengths of light to one of the multiple diodes. For some embodiments, the plurality of color filters are arranged in a Bayer pattern. Each of the multiple single-diode microlenses may be positioned within proximity of one of the color filters of the color filter array. Each of multi-pixel-microlens may be positioned within proximity of at least three adjacent color filters of the color filter array. Two of the at least three adjacent color filters may be configured to pass the same wavelengths of light to a first and second diode. One of the at least three adjacent color filters may be disposed between the two of the at least three adjacent color filters and configured to pass different wavelengths of light to a third diode. Light incident on each multi-pixel-microlens in a first direction may be collected in the first diode and light incident in a second direction may be collected in the second diode. The image signal processor may be configured to perform phase detection autofocus based on values received from the first and second diodes.

Another aspect of the present disclosure provides an image sensor. The image sensor may include multiple diodes, multiple single-diode microlenses, multiple multi-diode-microlenses, and an image signal processor. The multiple diodes may be configured to sense light from a target scene. Each of the multiple single-diode microlenses may be positioned adjacent to one of the multiple diodes. Each multi-pixel-microlens may be positioned adjacent to at least three linearly adjacent diodes of the multiple diodes. The at least three diodes may include a first and second diode disposed at the respective ends of the multi-pixel-microlens and a third diode positioned between the first and second diode. The light incident in a first direction may be collected in the first diode and light incident in a second direction may be collected in the second diode. The image an image signal processor may be configured to receive values representing the light incident on the first and second diodes and perform phase detection autofocus using the received values.

Another aspect of the present disclosure provides a method for constructing a final image. The method includes receiving image data from multiple diodes associated with multiple color filters arranged in a pattern. The image data includes multiple imaging pixel values from a first subset of the multiple diodes associated with a first subset of the multiple color filters and multiple multi-pixel-microlenses, and a second subset of the multiple diodes associated with a second subset of the multiple color filters and multiple single-diode microlenses. The image data may also include multiple phase detection pixel values from a third subset of the multiple diodes associated with a third subset of the multiple color filters and the multiple multi-pixel-microlenses. The third subset of the multiple diodes may be arranged in multiple groups of adjacent diodes including at least one diode of the first subset of the multiple diodes and at least two diodes of the third subset of the multiple diodes. Each group of the multiple groups may receive light from a corresponding multi-pixel-microlens formed such that light incident in a first direction is collected in a first diode of the third subset of the multiple diodes and light incident in a second direction is collected in a second diode of the third subset of the multiple diodes. The method also includes calculating a disparity based on the light collected in the first direction and light collected in the second direction to generate focus instructions, and constructing an image based at least partly on the multiple imaging pixel values and focus instructions.

Another aspect of the present disclosure provides an image signal processor configured by instructions to execute a process for constructing a final image. The process includes receiving image data from multiple diodes associated with multiple color filters arranged in a pattern. The image data includes multiple imaging pixel values from a first subset of the multiple diodes associated with a first subset of the multiple color filters and multiple multi-pixel-microlenses, and a second subset of the multiple diodes associated with a second subset of the multiple color filters and multiple single-diode microlenses. The image data may also include multiple phase detection pixel values from a third subset of the multiple diodes associated with a third subset of the multiple color filters and the multiple multi-pixel-microlenses. The third subset of the multiple diodes may be arranged in multiple groups of adjacent diodes including at least one diode of the first subset of the multiple diodes and at least two diodes of the third subset of the multiple diodes. Each group of the multiple groups may receive light from a corresponding multi-pixel-microlens formed such that light incident in a first direction is collected in a first diode of the third subset of the multiple diodes and light incident in a second direction is collected in a second diode of the third subset of the multiple diodes. The method also includes calculating a disparity based on the light collected in the first direction and light collected in the second direction to generate focus instructions, and constructing an image based at least partly on the multiple imaging pixel values and focus instructions.

### BRIEF DESCRIPTION OF THE DRAWINGS

The disclosed aspects will hereinafter be described in conjunction with the appended drawings and appendices, provided to illustrate and not to limit the disclosed aspects, wherein like designations denote like elements.

FIGS. 1A-1F depict schematic views of example arrangements for masked phase detection.

FIGS. 2A and 2B depict schematic views of an example arrangement for split pixel phase detection.

FIGS. 3A and 3B depict schematic views of an example arrangement of color filters, single-diode microlenses, and a dual-diode microlens for a phase detection image sensor.

FIGS. 3C-3E depict example interpolations to determine values that correspond to a sensor under the dual-diode microlens of FIGS. 3A and 3B.

FIG. 4 depicts a schematic view of an embodiment of a multi-pixel-microlens for a phase detection image sensor.

FIGS. 5A-5C depict example ray traces of light entering a pair of phase detection diodes at different focus conditions.

FIG. 6 depicts a schematic view of an example of phase detection using the example multi-pixel-microlens of FIG. 4.

FIGS. 7A and 7B depict example arrangements of color filters, single-diode microlenses, and a multi-pixel-microlens for a phase detection image sensor.

FIG. 8 depicts another example arrangement of color filters, single-diode microlenses, and a multi-pixel-microlens for a phase detection image sensor.

FIG. 9 depicts a high-level overview of an example phase detection autofocus process using a sensor having the multi-pixel-microlenses.

FIG. 10 depicts a schematic block diagram illustrating an example imaging system equipped with the phase detection autofocus devices and techniques.

FIG. 11 illustrates a flowchart depicting a method for constructing a final image, in accordance with an exemplary implementation.

### DETAILED DESCRIPTION

### Introduction

Embodiments of this disclosure relate to systems and techniques for mask-less phase detection pixels by using microlenses that extend over and within proximity to adjacent diodes of an image sensor (referred to herein as multi-pixel-microlenses). The phase difference detection pixels below the multi-pixel-microlenses are provided to obtain a phase difference signal indicating a shift direction (defocus direction) and a shift amount (defocus amount) of an image focus.

It should be noted that the term “diodes” or other variations of the word as used herein may be, for example, photodiodes formed in a semiconductor substrate. An example semiconductor substrate may be, for example, a complementary metal-oxide semiconductor (CMOS) image sensor. As used herein, diode refers to a single unit of any material, semiconductor, sensor element or other device that converts incident light into current. The term “pixel” as used herein can refer to a single diode in the context of its sensing functionality due to optical elements such as color filters or microlenses. Accordingly, although “pixel” generally may refer to a display picture element, a “pixel” as used herein may refer to a sensor (for example, a photodiode) that receives or senses light from a target and generates a signal which if rendered on a display, may be displayed as a point in an image captured by the sensor (and a plurality of other sensors). The individual units or sensing elements of an array of sensors, for example in a CMOS or charge-coupled device (CCD), can also be referred to as sensels.

It should be noted that the term “color filter” or other variations of the word as used herein may, for example, act as wavelength-selective pass filters that may “filter” or “split” incoming light in the visible range into component sub-ranges of the visible spectrum. For example, the color filters may split incoming light into red, green, and/or blue ranges (as indicated by the R, G, and B notation used throughout this application). The light is split or filtered by allowing only certain selected wavelengths to pass through each of the color filters. The filtered light may be received by dedicated red, green, or blue diodes on an image sensor. Although red, blue, and green color filters are commonly used, it should be understood that the color filters used in the embodiments described herein and throughout this application can vary according to the color channel requirements of the captured image data, for example including ultraviolet, infrared, or near-infrared pass filters.

As used herein, “over” and “above” refer to the position of a structure (for example, a color filter or lens) such that light incident from a target scene propagates through the structure before it reaches (or is incident on) another structure. To illustrate, a microlens array may be positioned above a color filter array, which is positioned above a diode array. Accordingly, light from the target scene first passes through the microlenses, then the color filter array, and finally is incident on the diodes.

Using multi-pixel-microlenses allows for substantially full brightness of the phase detection pixels. For example, the phase detection pixels have a similar brightness relative to adjacent imaging pixels, in contrast to masked phase detection pixels which exhibit reduced-brightness. Accordingly, embodiments described herein can produce a final image with fewer and/or less noticeable artifacts as compared to an image produced using a sensor with masked phase detection pixels. Also embodiments described herein can produce better performance of phase detection autofocus in low-light settings. Such multi-pixel-microlenses also provide for left and right phase detection pixels that are close to one another, for example, separated by an image pixel. Without subscribing to a particular scientific theory, such proximity may provide more accurate phase detection information than traditional phase detection pixels that are spaced apart to reduce artifacts in the final image. The accuracy of the phase detection information may be further improved by providing a strong and distinct separation of the left and right phase detection pixels, for example, by providing an image pixel between the left and right phase detection pixels.

Various embodiments will be described below in conjunction with the drawings for purposes of illustration. It should be appreciated that many other implementations of the disclosed concepts are possible, and various advantages can be achieved with the disclosed implementations. Headings are included herein for reference and to aid in locating various sections. These headings are not intended to limit the scope of the concepts described with respect thereto. Such concepts may have applicability throughout the entire specification.

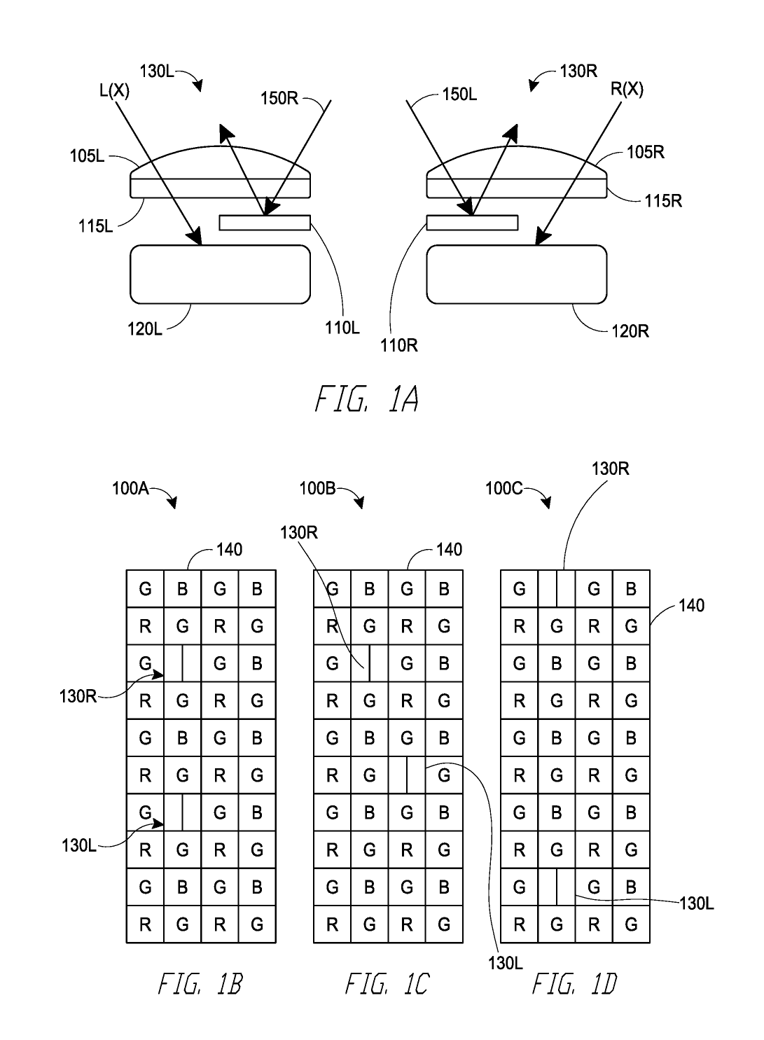

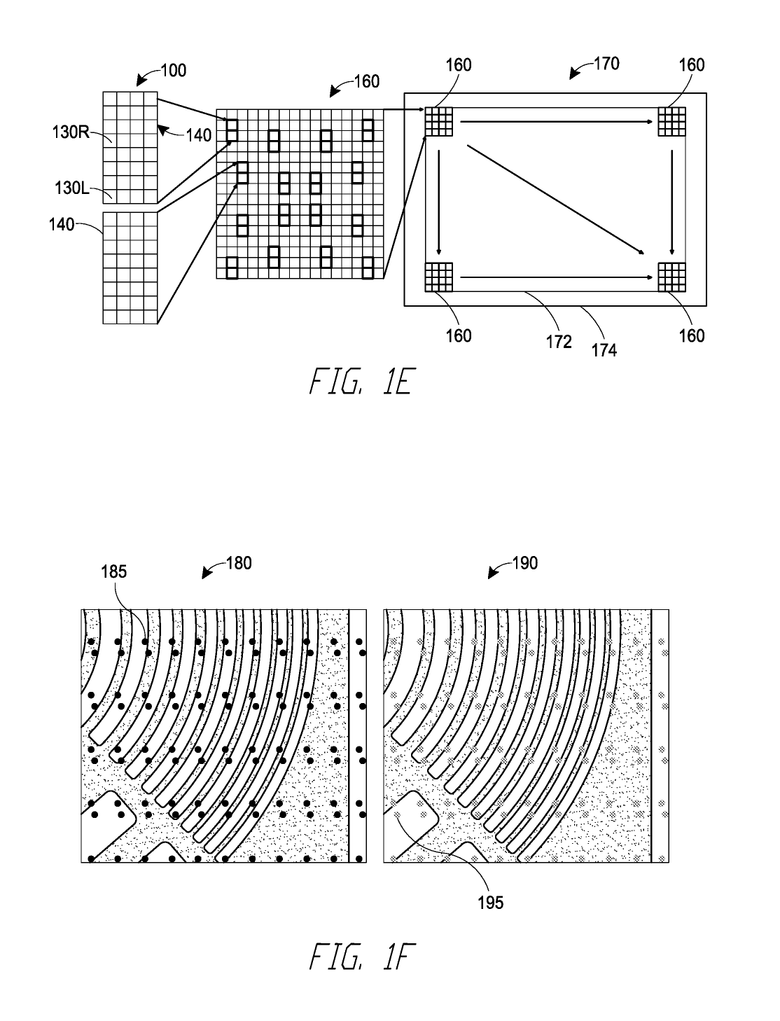

For example, FIGS. 1A-1F depict schematic views of example arrangements for masked phase detection. FIG. 1A depicts a schematic view of an example sensor portion 100 (as shown in FIGS. 1B-1D) including a phase detection pixel 130R and 130L, each comprising masks 110L and 110R, respectively. Each phase detection pixel 130L and 130R includes single-diode microlenses 105L and 105R, color filters 115L and 115R, and photodiodes (“diodes”) 120L and 120R, respectively. Masks 110L and 110R are sized and positioned such that incoming light from a target scene propagates through the single-diode microlens 105L or 105R and is partially blocked or reflected by the mask 110L or 110R before falling incident on the diodes 120L or 120R. By partially blocking the incident light, light incident in a first direction (L(X)) is collected in diode 120L, while light incident in a second direction 150R is blocked or reflected from the diode 120L. Similarly, light incident in the second direction (R(X)) is collected in diode 120R, while light incident in the first direction 150L is blocked or reflected from the diode 120R. Data received from diodes 120L and 120R can be used for phase detection.

FIGS. 1B-1D depict schematic views of example arrangements for a masked phase detection using sensor portions 100A-C. For example, as shown in sensor portions 100A-100C, the phase detection pixel 130R and 130L may be disposed at various positions throughout the sensor portion 100 in relation to image pixels 140. However, each phase detection pixel 130L and 130R are separated by multiple imaging pixels 140, thereby reducing the accuracy of the phase detection information.

FIG. 1E schematically illustrates multiple arrangements of sensor portions 100A-100C (collectively referred to hereinafter as “100”) in a display 170. The display 170 comprises an effective display area 174 that comprises a plurality of pixels. A subset of the plurality of pixels may be an autofocus area 172 that comprises one or more phase detection regions 160 spaced apart. The phase detection regions 160 include an array of image sensor portions and phase detection sensor portions 100 distributed therein, for example, as illustrated in FIG. 1E. In the embodiment illustrated herein, the phase detection region 160 comprises a unit block of 64 pixels×64 pixels comprising a plurality of sensor portions 100. As illustrated, each sensor portion 100 may comprise a 4 pixel×8 pixel pattern. While a specific example is depicted herein, it should be understood that this is for illustrative purposes only, and any configuration of pixels and any number of either phase detection regions 160 or sensor portions 100 may be used to provide the desired phase detection accuracy.

As noted above, the masked phase detection approach using sensor portion 100 including a phase detection pixels 130R and/or 130L may produce artifacts as compared to an image produced using a sensor comprising multi-pixel-microlenses as described herein. For example, FIG. 1F depicts images 180 and 190 produced using the display 170 of FIG. 1E. Image 180 illustrates several artifacts 185 resulting from the masks 110L and 110R. Image 190 is also produced using the display 170 depicting similar artifacts 195, but includes post image processing to reduce the appearance of the artifacts 195. However, the artifacts 185 and 195 still persist, thereby affecting the final image.

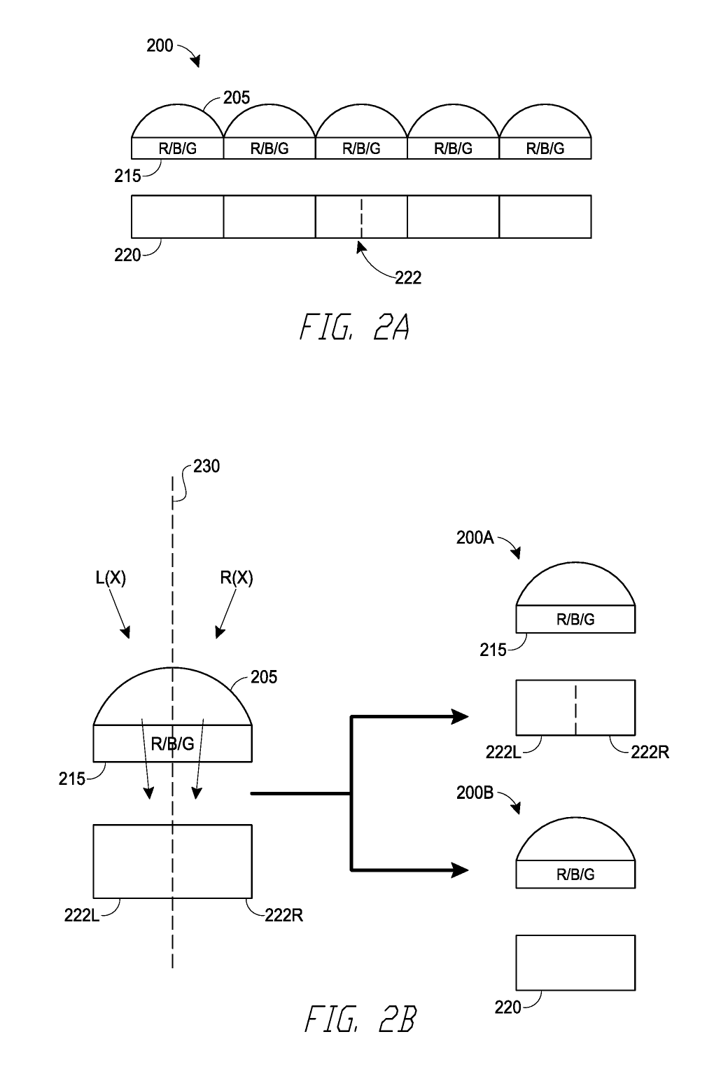

FIGS. 2A and 2B schematically illustrate another example phase detection using another approach, hereinafter referred to as “split pixel.” FIG. 2A depicts a schematic view of an example sensor portion 200. The sensor portion 200 may be similar to sensor portion 100. The sensor portion 200 includes an array of single-diode microlenses 205, color filters 215, and diodes 220. However, each combination of single-diode microlenses 205, color filters 215, and photodiodes 220 may operate as an image pixel for obtaining imaging information in an image mode (as shown in sensor portion 200A of FIG. 2B). Furthermore, as shown in sensor portion 200B, one or more of the photodiodes 220 may function as a phase detection pixel for obtaining phase detection information during a phase detection mode. For example, as depicted in FIG. 2B, photodiode 222 may be configured to switch to a phase detection pixel during auto focusing. The photodiode 222 may be “split” along (dashed) line 230 into a first portion 222L and a second portion 222R that are independently capable of capturing light. It should be understood that the term “split” as used in connection to FIGS. 2A and 2B is not a physical split, but rather that light from a first direction (L(X)) is collected in a first portion 222L of diode 222 and light from a second direction (R(X)) is collected in a second portion 222R. Accordingly, the single-diode microlens 205 is formed such that light incident from the first direction (L(X)) is directed toward the first portion 222L and light from the second direction (R(X)) is directed toward the second portion 222R. Data received from portions 222L and 222R of diode 222 can be used for phase detection.

However, the split pixel approach of FIGS. 2A and 2B may suffer from several disadvantages. For example, this approach may require a complicated process to switch between the image mode and the phase detection mode. In some implementations, non-standard processing techniques may be needed for processing the image data and/or the phase detection data. Furthermore, the approach of FIGS. 2A and 2B may require a high density of relatively large pixels, due to the requirement that each phase detection pixel be configured to independently capture light from different directions. Thus, this approach may be prohibitive to small form factor applications, such as, for example, mobile telephones, tablet computers, and other small displays requiring high resolution. Using multi-pixel-microlenses as described herein may provide advantages in avoiding these drawbacks of the split pixel phase detection approach, while also providing substantially full brightness of the phase detection pixels. These non-limiting advantages may provide improved phase detection information over metal mask implementations as described above.

According to the embodiments described herein, color filters placed between a multi-pixel-microlens and the corresponding diodes used for phase detection can be selected to pass the same wavelengths of light. The multi-pixel-microlens may correspond to a plurality of adjacent diodes, where two diodes are associated with a color filter selected to pass the same wavelength or wavelengths of light. The plurality of adjacent diodes may also include a third diode associated with a color filter selected to pass a different wavelength or wavelengths of light than the aforementioned color filters. By using multiple color filters under a multi-pixel-microlens, the color filters placed between single-diode and multi-pixel-microlenses and corresponding diodes can follow the standard Bayer pattern, without a need for complex and expensive image signal processing following capturing the final image. For example, in current implementations, a non-standard Bayer pattern is compensated for through image processing techniques. These techniques may not be optimal when used with image processing hardware designed for operation using a standard Bayer pattern. Furthermore, by using multiple diodes that receive a single color “under” each multi-pixel-microlens used for phase detection, a pixel color value can be more accurately calculated as compared to a sensor having different color filter colors under a microlens. In one embodiment, at least two of the color filters disposed between the multi-pixel-microlens and the corresponding diodes can be selected to pass blue light. Accordingly, blue correction is unnecessary or trivial and the resulting image data may not require correction of any blue pixel information by having defective or missing blue pixel information, because blue pixels are the least important for human vision. In some embodiments, by having at least one diode disposed between the two diodes used for phase detection, the left and right phase detection pixels may be separated to provide accurate phase detection values for each phase detection. In one embodiment, at least one color filter positioned between the colors filters of the phase detection pixels (e.g., the color filters configured to pass the same wavelength of light) and disposed between the multi-pixel-microlens and the corresponding diodes can be selected to pass green light. Accordingly, green correction is trivial and the resulting image data does not lose any green pixel information by having defective or missing green pixel information because the green pixel is used for obtaining imaging information and green pixels are particularly important for human vision.

Red, green, and blue, as used herein to describe pixels or color filters, may refer to wavelength ranges roughly following the color receptors in the human eye. Exact beginning and ending wavelengths (or portions of the electromagnetic spectrum) that define colors of light (for example, red, green, and blue light) are not typically defined to be a single wavelength. Each color filter can have a spectral response function within the visible spectrum, and each color channel resulting from placement of a color filter over a portion of the image sensor can have a typical human response function. Image sensor filter responses are more or less the same, however may change from sensor to sensor.

The image sensors used to capture phase detection autofocus information as described herein may be used in conjunction with a color filter array (CFA) or color filter mosaic (CFM). Such color filters split all incoming light in the visible range into red, green, and blue categories to direct the split light to dedicated red, green, or blue photodiode receptors on the image sensor. As such, the wavelength ranges of the color filter can determine the wavelength ranges represented by each color channel in the captured image. Accordingly, a red channel of an image may correspond to the red wavelength region of the color filter and can include some yellow and orange light, ranging from approximately 570 nm to approximately 760 nm in various embodiments. A green channel of an image may correspond to a green wavelength region of a color filter and can include some yellow light, ranging from approximately 570 nm to approximately 480 nm in various embodiments. A blue channel of an image may correspond to a blue wavelength region of a color filter and can include some violet light, ranging from approximately 490 nm to approximately 400 nm in various embodiments.

Although discussed herein primarily in the context of phase detection autofocus, the phase detection image sensors and techniques described herein can be used in other contexts, for example generation of stereoscopic image pairs or sets.

### Overview of an Example Phase Detection Microlens and Color Filter Arrangements

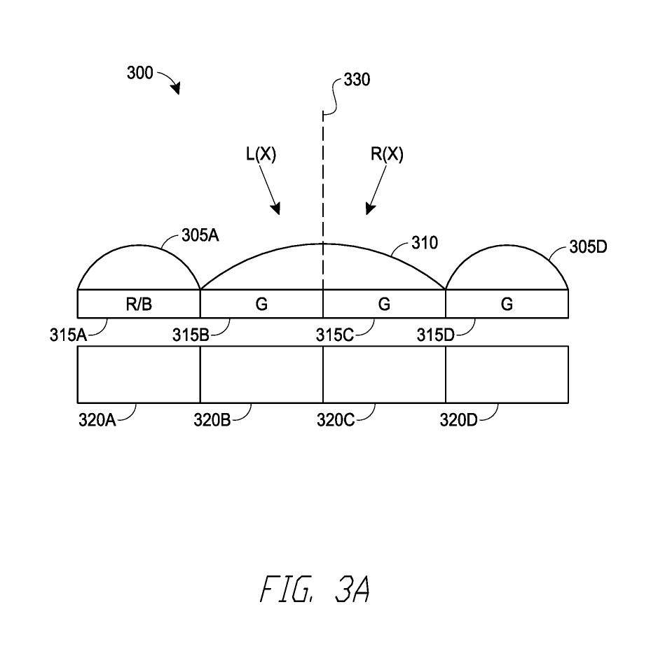

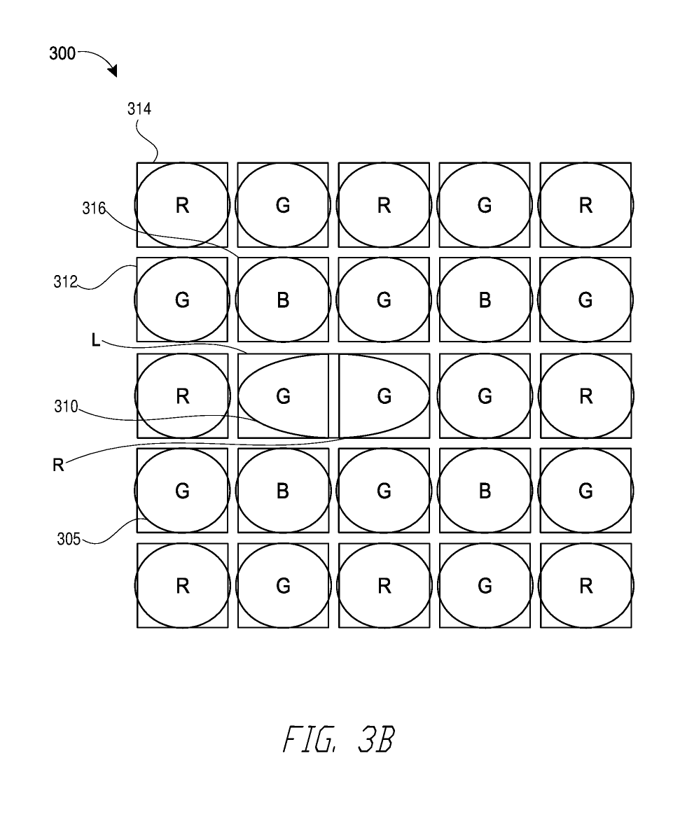

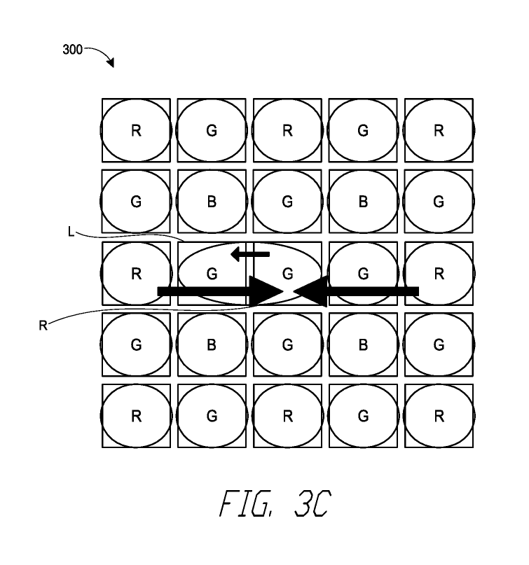

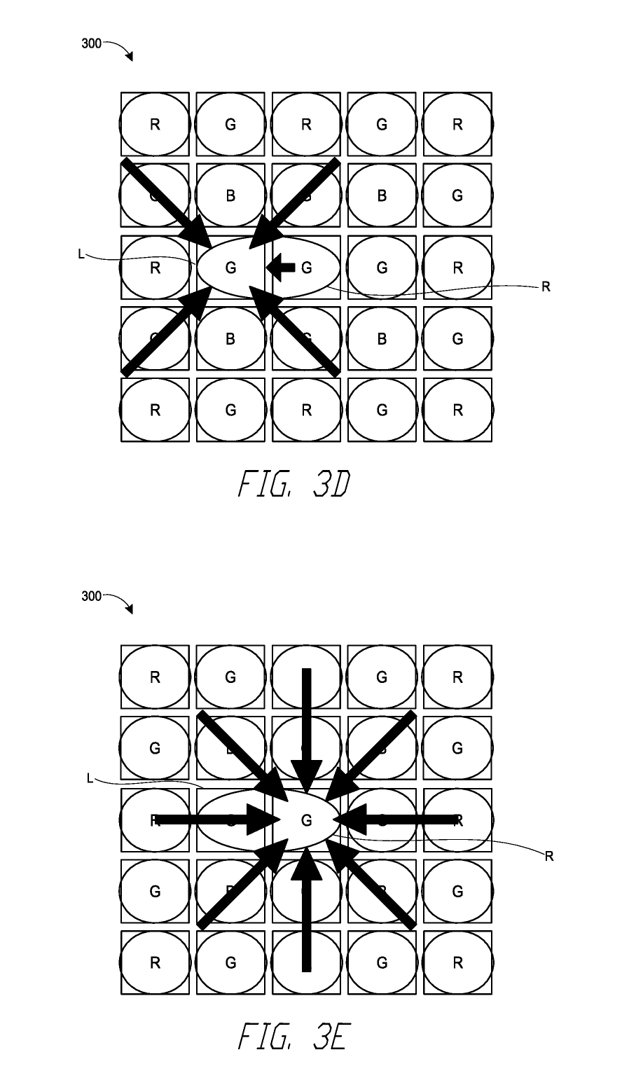

FIGS. 3A and 3B depict a schematic view of an example arrangement of a sensor portion 300 including a dual-diode microlens 310. The sensor portion 300 also may include a plurality of single-diode microlenses 305A, 305D, dual-diode microlens 310, color filters 315A-315D, and photodiodes 320A-320D. Dual-diode microlens 310 may be sized and positioned such that incoming light from a target scene propagates through the dual-diode microlens 310 before falling incident on the diodes 320B, 320C covered by the dual-diode microlens 310.

Color filters 315A-315D act as wavelength-selective pass filters and, as described above, may filter incoming light in the visible range into red, green, and blue ranges (as indicated by the R, G, and B). The light is filtered by allowing only certain selected wavelengths to pass through the color filters 315A-315D. The split light is received by dedicated red, green, or blue diodes 320A-320D on the image sensor. Although red, blue, and green color filters are commonly used, in other embodiments the color filters can vary according to the color channel requirements of the captured image data, for example including ultraviolet, infrared, or near-infrared pass filters.

Each single-diode microlens 305A and 305D is positioned over a single color filter 315A and 315D and a single diode 320A and 320D, respectively. Diodes 320A and 320D accordingly provide imaging pixel information. Dual-diode microlens 310 is positioned over and within proximity to two adjacent color filters 315B and 315C and two corresponding adjacent diodes 320B and 320C, respectively. Diodes 320B and 320C accordingly provide phase detection pixel information by diode 320B receiving light entering dual-diode microlens 310 in a first direction (L(X)) and diode 320C receiving light entering dual-diode microlens 310 in a second direction (R(X)). In some embodiments, the dual-diode microlens 310 can be a planoconvex lens having a circular perimeter, where the at least one dual-diode microlens may be sized to pass light to a 2×2 cluster of diodes of the plurality of diodes. In other embodiments, the dual-diode microlens 110 can be a planoconvex lens having an oval perimeter, where the at least one dual-diode microlens may be sized to pass light to a 2×1 cluster of diodes of the plurality of diodes, as described in connection with FIG. 3B below.

The microlens array comprising single-diode microlenses 305A, 310, and 305D can be positioned above the color filter array 315A-315D, which is positioned above the diodes 320A-320D. Accordingly, light from the target scene first passes through the microlenses 305A, 310, and 305D, then the color filter array 315A-315D, and finally is incident on the diodes 315A-315D.

Placement of the microlenses above each photodiode 320A-320D redirects and focuses the light onto the active detector regions. Each microlens may be formed by dropping the lens material in liquid form onto the color filters 315A-315D on which the lens material solidifies. In other embodiments, wafer-level optics can be used to create a one or two dimensional array of microlenses using semiconductor-like techniques, where a first subset of the microlenses in the array include single-diode microlenses and a second subset of the microlenses in the array include dual-diode microlenses. As illustrated by single-diode microlens 305A and 305D and dual-diode microlens 310, each microlens may be a single element with one planar surface and one spherical convex surface to refract the light. Other embodiments of the microlenses may use aspherical surfaces, and some embodiments may use several layers of optical material to achieve their design performance.

Color filters 315A and 315D under single-diode microlenses 305A and 305D can be positioned according to the Bayer pattern in some embodiments. Accordingly, color filter 315A is either a red color filter or a blue color filter, while color filter 315D is a green color filter. Preserving the Bayer pattern for diodes 320A and 320D and other diodes under single-diode microlenses can provide computational benefits, for example enabling use of widespread demosaicking techniques on captured image data. The Bayer pattern is a specific pattern for arranging RGB color filters on a rectangular grid of photosensors. The particular arrangement of color filters of the Bayer pattern is used in most single-chip digital image sensors used in digital cameras, camcorders, and scanners to create a color image. The Bayer pattern is 50% green, 25% red and 25% blue with rows of repeating red and green color filters alternating with rows of repeating blue and green color filters.

Although the color filters over which the single-diode microlenses 305A and 305D are positioned are described herein in the context of the Bayer pattern arrangement, such color filters can be arranged in other patterns that are 50% green color filters, 25% blue color filters, and 25% red color filters. Other patterns that include more green color filters than blue or red color filters are possible or other patterns that have generally twice as many green color filters as blue or red color filters. The color filters can also be positioned according to other color filter patterns in some embodiments, for example color filter patterns designed for use with panchromatic diodes (sensitive to all visible wavelengths) and/or color filters for passing light outside of the visible spectrum.

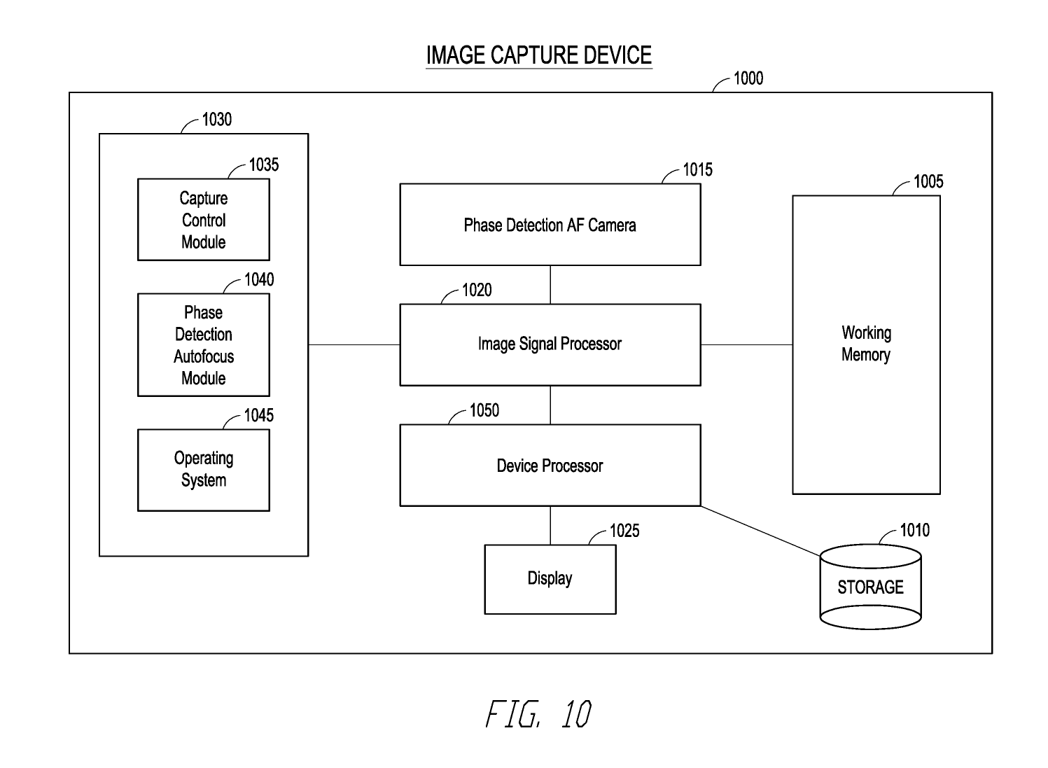

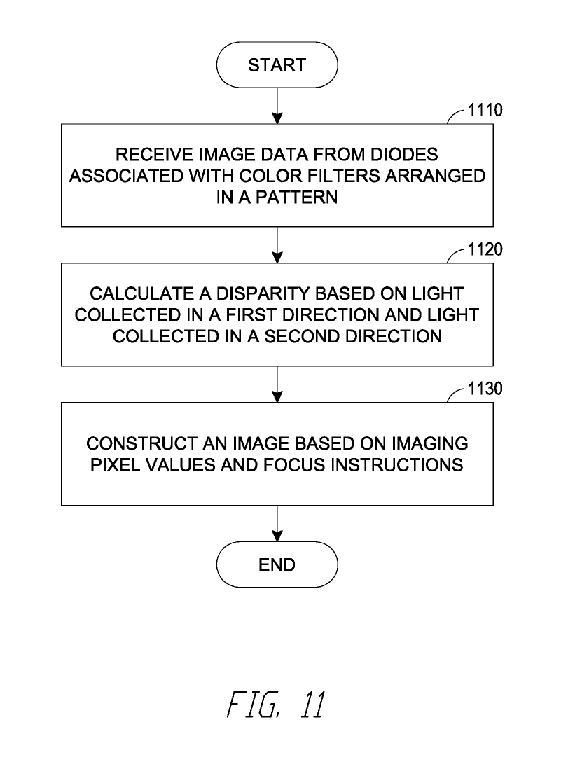

As depicted in FIG. 3A with reference to green color filter 315C, at least some of the color filters 315B and 315C positioned below the dual-diode microlens 310 may be different from a color filter that would otherwise be positioned in that location according to the Bayer pattern. Color filters 315B and 315C between the dual-diode microlens 310 and the corresponding diodes 320B and 320C can be selected to pass green light. Such an arrangement may require correction of or reconstruction of the green pixel, for example, by combining the values from diodes 320B and 320C. This reconstruction may be carried out in image signal processing executed by the hardware components of the imaging device following image capture of a scene (e.g., image signal processor 1020 of FIG. 10). In some embodiments, the resulting image data may maintain most of the green channel information due to the defective or missing green pixel information, as the green channel is particularly important for human vision. One possible drawback is that the center of the green color filter 315B and 315C may be shifted horizontally by ½ a pixel from the original green pixel location in the Bayer pattern. Accordingly, in some embodiments, the values of the diodes 320B and 320C may be combined via image processing techniques to reduce any noticeable consequences with respect to quality of the final image. An example of combining the values from diodes 320B and 320C is provided to illustrate one process for performing green correction via interpolation, for example, as illustrated in FIG. 3C. However in other implementations correction can be performed via higher order interpolation, such as by using additional green pixels in a predefined neighborhood, for example, as illustrated in FIG. 3D.

In some embodiments, the “missing” color filter that is replaced by the green color filter 315C under the dual-diode microlens 310 can be a blue color filter, as the blue channel of image data is the least important for quality in terms of human vision. In other embodiments, green color filter 315C can be in the location where a red color filter would be if not for interruption of the color filter pattern due to the dual-diode microlens 310.

FIG. 3A also depicts (dashed) line 330 which should be understood is not a physical structure but rather is depicted to illustrate the phase detection capabilities provided by dual-diode microlens 310. The line 330 passes through the optical center of the dual-diode microlens 310 and passes orthogonally to a plane formed by the color filter array of color filters 315A-315D. Where dual-diode microlens 310 is a 2×1 microlens, the dual-diode microlens 310 is formed such that light L(X) incident in a first direction, that is, entering the dual-diode microlens 310 from one side of the line 330, is collected in a first diode 320B. Light incident in a second direction (R(X)), that is, entering the dual-diode microlens 310 from the other side of the line 330, is collected in a second diode 320C. Accordingly, data received from diodes 320B and 320C can be used for phase detection.

FIG. 3B depicts an example arrangement of color filters 312, 314, and 316, single-diode microlenses 305, and a dual-diode microlens 310 for a phase detection image sensor portion 300 as described herein. Only a portion of sensor portion 300 is illustrated, and this portion can be repeated across the sensor array or interspersed in selected phase detection locations in the Bayer pattern depending on the desired balance between number of phase detection pixels and image quality.

As illustrated, a number of green color filters 312, red color filters 314, and blue color filters 316 are arranged in the Bayer pattern under a number of single-diode microlenses 305. Each color filter is called out once using reference numbers 312, 314, or 316 and shown throughout the remainder of the figures using G, R, or B for simplicity of the illustration. However, at the location of the dual-diode microlens 310 the Bayer pattern is interrupted and an additional green color filter is inserted at the location of the right phase detection pixel. As such, there is a “missing” red filter at the location of the right phase detection pixel. In the illustrated embodiment, the right phase detection pixel green color filter replaces what would otherwise, according to the Bayer pattern, be a red color filter. In other embodiments the phase detection pixel green color filter can replace a blue color filter.

FIG. 3C depicts a representation of an example of interpolation of values under the dual-diode microlens 310 of FIG. 3A. Such interpolation can provide pixel values (representing color and brightness of the phase detection pixels) for output to a demosaicking process for use in generating a final image of the target scene, and can be performed by image signal processor 1020 of FIG. 10 in some embodiments.

As illustrated, the left phase detection pixel (L) value can be determined by summing the green values of the left and right phase detection pixels under the dual-diode microlens 310. The summed green value is assigned to the left phase detection pixel as the Bayer pattern used to arrange the color filters under the single-diode microlenses specifies a green pixel in the location of the left phase detection pixel. The small phase shift of the summed green value may provide improved green aliasing. In some embodiments, the summed value may be divided by the number of diodes under the microlens (here, two) to obtain the green value.

As illustrated, the right phase detection (R) pixel value can be determined by interpolation using two nearby red pixel values (values received from the diodes under red color filters). Two horizontally located red pixels are illustrated for the interpolation, however alternatively or additionally two vertically located red pixels can be used. The interpolated value is assigned to the right phase detection pixel as the Bayer pattern used to arrange the color filters under the single-diode microlenses specifies a red pixel in the location of the right phase detection pixel.

In some embodiments, interpolation as depicted for the green value and missing pixel value of FIG. 3B does not require any line buffers, can be made prior to the standard demosaicking process, and can even be performed on-sensor.

FIG. 3D depicts a representation of another example of interpolation of values under the dual-diode microlens 310 of FIG. 3A. As illustrated, the left phase detection pixel (L) value can be determined by summing the green values of the left and right phase detection pixels under the dual-diode microlens 310 and green values received from four diodes under green color filters (referred to as “green pixel values”) in a 3×3 neighborhood with the left phase detection pixel at its center. The green value is assigned to the left phase detection pixel. In some embodiments, the summed value may be divided by the number of diodes used to determine the green value (here, 5) to obtain the green value. The right phase detection pixel (R) value can be determined as described above in connection to FIG. 3C or below in connection with FIG. 3E.

FIG. 3E depicts a representation of another example of interpolation for values under the dual-diode microlens 310 of FIG. 3A, and can be performed by image signal processor 1020 of FIG. 10 in some embodiments. Here, red values received from eight diodes under red color filters (referred to as “red pixel values”) in a 5×5 neighborhood with the right phase detection pixel (R) at its center are used to interpolate the “missing” red pixel value. In other implementations, data from a different predetermined neighborhood of surrounding diodes can be used for interpolation, for example four neighboring red pixel values. In some embodiments, the summed value may be divided by the number of diodes used to determine the red value (here, 8) to obtain the missing red value. Although FIGS. 3C-3E depict examples for interpolating the missing pixel color value, other interpolation techniques can be suitable, for example using greater or fewer numbers of pixel values for the interpolation. Further, in some embodiments, the pixel having the “missing” color filter can be designated as a defective pixel and a defective pixel compensation process can be used to determine its value.

The decision regarding which neighboring pixels to use for calculating the “missing” pixel value can be predetermined or can be adaptively selected from a range of pre-identified alternatives, for example based on calculated edge data. In some embodiments, the missing pixel under the dual-diode microlens 310 may be recorded as a defective pixel. The image signal processor (e.g., image signal processor 1020 of FIG. 10) may rely on defective pixel compensation and processing techniques stored therein.

### Overview of Another Example Phase Detection Microlens and Color Filter Arrangements

According to the embodiments described herein, two or more color filters placed between a multi-pixel-microlens and the corresponding diodes can be selected to pass the same wavelengths of light. In some embodiments, the color filters and miroclenses are positioned within proximity of the diodes. In various embodiments, the color filters may be adjacent to the diodes. The color filters placed between the single-diode and multi-pixel-microlens and corresponding diodes can follow the standard Bayer pattern. Each multi-pixel-microlens may be positioned within proximity of, for example, at least three adjacent color filters, where two of the color filters are configured to pass the same wavelengths of light. The three or more adjacent color filters, and corresponding diodes, can be arranged in a row or column. The two color filters that pass the same wavelength of light are disposed on opposite sides of at least one other color filter positioned within proximity of the multi-pixel-microlens. The at least one other adjacent color filter is configured to pass different wavelengths of light to a corresponding diode. In some embodiments, the two color filters that pass the same wavelength of light, and corresponding diodes, are disposed at opposite ends of the multi-pixel-microlens. In another embodiment, the two color filters that pass the same wavelength of light, and corresponding diodes, need not be positioned at the ends of the multi-pixel-microlens, for example, disposed on opposite sides of a central axis of the multi-pixel-microlens.

By having two diodes that receive the same color “under” each multi-pixel-microlens, a pixel color value can be more accurately calculated compared to a sensor having multiple different color filter colors under a multi-pixel-microlens. Furthermore, by having at least one diode between the two diodes that receive the same wavelengths of light, the color filters may be arranged in a standard Bayer pattern, which may reduce or minimize the need for complicated reconstruction and interpolation described above in connection to FIGS. 3A-3C. For example, the “missing” pixel values need not be interpolated or there may not be a horizontal shift of the pixel from the original pixel location in the Bayer pattern.

In some embodiments, a single-diode microlens may focus most or all of the received light onto the diode, thereby focusing the received light onto the active detector region. However, in some embodiments using microlenses within proximity of two or more diodes (e.g., dual-diode or multi-pixel-microlenses), the microlens may have a shape that does not equate to that of a single-diode microlens. Thus, in some embodiments, less than all of the received light may be focused onto the corresponding diode. For example, focusing of light may be affected by the shape of the microlens, thus some of the light may not be received by the diode and, instead, may be incident on non-active detector regions of the pixel (e.g., transistors, wires, etc. using for sending and receiving information to and from the pixel). Accordingly, in some embodiments, the need for reconstruction and interpolation may be based on a pixel fill factor, for example, the ratio between the area of the active detector region (e.g., diode area) and the entire pixel (e.g., active and non-active detector regions). The pixel fill factor may also be indicative of the amount or percentage of the light received by the microlens that is focused onto the active detector region for use as image data and/or in phase detection.

Without subscribing to a particular scientific theory, the human eye is partially sensitive to green light, therefore, green pixels may be particularly important for human vision. In one embodiment, at least two color filters disposed between the multi-pixel-microlens and the corresponding diodes can be selected to pass red or blue light. The at least two color filters may be used for phase detection. While another (or third) color filter is positioned between the at least two color filters and can be selected to pass green light for use in obtaining image information. In this embodiment, based on optical properties (e.g., shape, optical power, focusing properties, etc.) of the portion of the multi-pixel-microlens within proximity of or associated with the green microlens, the amount of light focused onto the diode may be similar to the amount of light focused by a single-diode microlens. For example, by using a central portion of the microlens, the shape may be configured to focus an amount of light that is similar to a single-diode microlens. The amount of light focused onto the active detector region may also be based on the pixel fill factor. For example, if the light is not focused in the same manner as the single-diode microlens, a larger diode will be capable of receiving more of the light focused by the multi-pixel-microlens.

Accordingly, green correction may be trivial or rendered unnecessary and the resulting image data does not lose green pixel information by having defective or missing green pixel information, because almost all of the green pixel is used for obtaining imaging information. In some embodiments, green correction may be trivial if the difference between the light focused onto the diode by the multi-pixel-microlens is less than a threshold of the amount of light focused by a single-diode microlens, because a difference of less than the threshold may be unnoticeable in an image. For example, green correction may be unnecessary where the difference is less than 20% or 10%, because the effect on the pixel information may be unnoticeable at less than the threshold. If the difference is over the threshold, reconstruction or interpolation, as described above in connection to FIGS. 3C-3E may be used. For example, where green correction may be needed, the phase detection pixel may be determined by summing the values of the phase detection pixels under the multi-pixel-microlens or the green pixels in a predefined neighborhood. The summed value may be divided by the number of pixels used in determining the sum. Although the description herein refers to an example for reconstructing and interpolating the missing pixel color value, other techniques can be suitable, for example using greater or fewer numbers of pixel values for the interpolation. In some embodiments, less destructive noise reduction algorithms may be implemented to compensate for noticeable differences in the pixel information. However, the threshold may be based on the image signal processing hardware implemented in the imaging device.

In some embodiments, in the alternative or in combination, the at least two color filters disposed between a multi-pixel-microlens and the corresponding diodes can be selected to pass blue light. By using blue color filters, correction may be unnecessary or trivial and the resulting image data may not require correction of any blue pixel information by having defective or missing blue pixel information, as blue pixels are the least important for human vision. As described above, the need to correct the pixel information may be based on the optical properties of the multi-pixel-microlens and/or the pixel fill factor. In some embodiments, blue correction may be trivial if the difference between the light focused onto the diode by the multi-pixel-microlens is less than a threshold value of the amount of light focused by a single-diode microlens. For example, blue correction may be unnecessary where the difference is less than 20% because the effect on the pixel information may be unnoticeable or compensated for by less destructive noise reduction algorithms However, the threshold may be less than or more then 20% based on the image signal processing hardware implemented in the imaging device. As described above, the reconstruction or interpolation may be carried out in a manner similar to that described in connection to FIGS. 3C-3E. Other configurations are possible, for example, the at least two color filters may be selected to pass red or green light, and the third color filter may be selected to pass red or blue light.

In some embodiments, a multi-pixel-microlens may have optical properties and optical powers that are different than the single-diode microlens. Light entering a single-diode microlens may be differently focused onto a corresponding diode than light entering a multi-pixel-microlens and focused onto one of the corresponding diodes, for example, a diode positioned away from the edges of the multi-diode lens. In some embodiments, the multi-pixel-microlens may be formed such that light focused onto diodes corresponding to imaging pixels may be substantially similar to light focused onto imaging pixels corresponding to a single-diode microlens. For example, the multi-pixel-microlens may be formed such that light focused onto diodes corresponding to imaging pixels may be approximately 10% less than light focused onto imaging pixels corresponding to a single-diode microlens. However, other configurations are possible based on the desired performance and characteristics of the image devices. Accordingly, correction is unnecessary or trivial and the resulting image data may not require correction due to defective or missing imaging pixel information, because the image pixel information obtained therefrom will be substantially similar to that obtained by a single-diode microlens. As described above, the need to correct for defective or missing imaging pixel information may be based on or connected to the pixel fill factor and/or the amount of light focused onto the active detector region versus the amount of light focused onto the entire pixel.

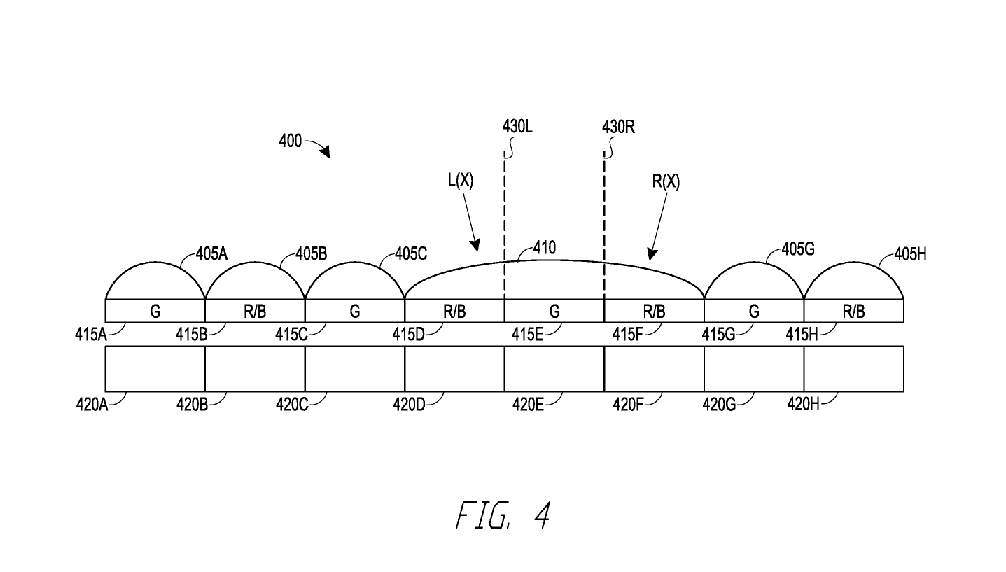

FIG. 4 depicts a schematic view of an example sensor portion 400 including a multi-pixel-microlens 410 as described herein. The sensor portion 400 includes single-diode microlenses 405A-C, 405G, and 405H, multi-pixel-microlens 410, color filters 415A-415H, and diodes 420A-420H. Multi-pixel-microlens 410 is sized and positioned such that incoming light from a target scene propagates through the multi-pixel-microlens 410 before falling incident on the diodes 420D, 420E, and 420F covered by the multi-pixel-microlens 410.

As described above in connection to FIGS. 3A-3C, color filters 415A-415H act as wavelength-selective pass filters and split incoming light in the visible range into red, green, and blue ranges (as indicated by the R, G, and B notation used throughout the Figures). The light is filtered by allowing only certain selected wavelengths to pass through the color filters 415A-415H. The filtered light is received by dedicated red, green, or blue diodes 420A-420H on the image sensor. Although red, blue, and green color filters are commonly used, in other embodiments the color filters can vary according to the color channel requirements of the captured image data, for example including ultraviolet, infrared, or near-infrared pass filters.

Each single-diode microlens 405A-C, 405G, and 405H is positioned over a single color filter 415A-C, 415G, and 415H and a single diode 420A-C, 420G, and 420H, respectively. Diodes 420A-C, 420G, and 420H accordingly provide imaging pixel information. Multi-pixel-microlens 410 is positioned over and within proximity of three adjacent color filters 415D, 415E, and 415F and three corresponding adjacent diodes 420D, 420E, and 420F, respectively. In the embodiments described herein, diodes 420D and 420F may be configured to provide phase detection pixel information based on diode 420D receiving light entering a corresponding portion of the multi-pixel-microlens 410 in a first direction (L(X)) and diode 420F receiving light entering a corresponding portion of the multi-pixel-microlens 410 in a second direction (R(X)). Diode 420E, disposed between the diodes 420D and 420F, may provide imaging pixel information by receiving light entering the multi-pixel-microlens 410. In some embodiments, the multi-pixel-microlens 410 can be a planoconvex lens having an oval perimeter, where the at least one multi-pixel-microlens may be sized to pass light to a 3×1 cluster of diodes of the plurality of diodes. While a specific example multi-pixel-microlens 410 is described herein, it should be understood that other configurations are possible. For example, any number of diode clusters may be disposed under the multi-pixel-microlens so long as at least two diodes correspond to color filters that pass the same wavelength of light.

As used herein, “over” and “above” refer to the position of a structure (for example, a color filter or lens) such that light incident from a target scene propagates through the structure before it reaches (or is incident on) another structure. To illustrate, the microlens array 405A-C, 410, 405G, and 405H is positioned above the color filter array 415A-415H, which is positioned above the diodes 420A-420H. Accordingly, light from the target scene first passes through the microlens array 405A-C, 410, 405G, and 405H, then the color filter array 415A-415H, and finally is incident on the diodes 420A-420H.

Placement of the microlenses above each photodiode 420A-420H redirects and focuses the light onto the active detector regions. Each microlens may be formed by dropping the lens material in liquid form onto the color filters 415A-415H on which the lens material solidifies. In other embodiments, wafer-level optics can be used to create a one or two dimensional array of microlenses using semiconductor-like techniques, where a first subset of the microlenses in the array include single-diode microlenses and a second subset of the microlenses in the array include multi-pixel-microlenses. As illustrated by single-diode microlens 405A-C, 405G, and 405H and multi-pixel-microlens 410, each microlens may be a single element with one planar surface and one spherical convex surface to refract the light. Other embodiments of the microlenses may use aspherical surfaces, and some embodiments may use several layers of optical material to achieve their design performance In some embodiments, the multi-pixel-microlenses may be shaped and designed to optimize light focused onto variously sized pixels. In some implementations, the pixels described herein may be 1 micron by 1 micron. Accordingly, the multi-pixel-microlens may be 1 micron by 3 microns where the multi-pixel-microlens is associated with three diodes. However, other dimensions are possible based on the dimensions of the corresponding pixels and diodes under the microlenses.

Color filters 415A-H under the microlens array 405A-C, 410, 405G, and 405H can be positioned according to the Bayer pattern in some embodiments. As described above in connection to FIGS. 3A-3C, the Bayer pattern is a specific pattern for arranging RGB color filters on a rectangular grid of photosensors. The particular arrangement of color filters of the Bayer pattern is used in most single-chip digital image sensors used in digital cameras, camcorders, and scanners to create a color image. The Bayer pattern is 50% green, 25% red, and 25% blue with rows of repeating red and green color filters alternating with rows of repeating blue and green color filters. Accordingly, as illustrated in the embodiment of FIG. 4, color filter 415A, 415C, 415E, and 415G are green color filters, while color filters 415B, 415D, 415F, and 415H are either red or blue color filters. In some embodiments, color filters 415A, 415C, 415E, and 415G are red or blue color filters, while color filters 415B, 415D, 415F, and 415H are green color filters. Accordingly, the embodiments disclosed herein preserve the Bayer pattern for diodes 420A-H, thereby reducing the need to perform reconstruction and/or interpolate pixel values for diodes under the multi-pixel-microlens 410. For example, since the Bayer pattern is maintained throughout sensor portion 400, there are no “missing” pixels that need to be interpolated to provide imaging pixel information.

Although the colors are described herein in the context of the Bayer pattern arrangement, such color filters can be arranged in other patterns that are 50% green color filters, 25% blue color filters, and 25% red color filters. Other patterns are also possible, for example, that include more green color filters than blue or red color filters, or other patterns that have generally twice as many green color filters as blue or red color filters. The color filters can also be positioned according to other color filter patterns in some embodiments, for example color filter patterns designed for use with panchromatic diodes (sensitive to all visible wavelengths) and/or color filters for passing light outside of the visible spectrum.

As depicted in FIG. 4, at least two of the color filters 415D, 415F positioned below the multi-pixel-microlens 410 may be selected to pass the same wavelength (or range of wavelengths) while a third color filter 415E is selected to pass a different wavelength (or range of wavelengths) thereby maintaining the Bayer pattern. As in the illustrated embodiment, color filters 415D, 415F between the multi-pixel-microlens 410 and the corresponding diodes 420D, 420F can be selected to pass red or blue light, while color filter 415E is selected to pass green light. Accordingly, as described above, green correction is unnecessary as full green pixel values may be obtained from the diode 420E. Furthermore, as described above, blue and/or red correction is unnecessary as red and/or blue pixel values are not as necessary for obtaining image information based on the response of the human eye. As such, the resulting image data does not lose much pixel value information by having defective or missing pixel information. However, while correction of pixel information is unnecessary due to the minimal defects or “missing” pixels, it should be understood that the image signal processing described above in connection to FIGS. 3C-3E may be applied to the embodiments herein as desired.

FIG. 4 also depicts (dashed) lines 430L and 430R which should be understood are not physical structures, but rather are depicted to illustrate the phase detection capabilities provided by multi-pixel-microlens 410. The lines 430L and 430R pass through the multi-pixel-microlens 410 to illustrate portions or regions of the multi-pixel-microlens 410 for use in phase detection. The lines 430R and 430L also illustrate portions of multi-pixel-microlens that correspond to color filters 415D-415F and diodes 420D-420F, respectively, and passes orthogonally to a plane formed by the color filter array of color filters 415A-415H. Where multi-pixel-microlens 410 is a 3×1 microlens, the multi-pixel-microlens 410 is formed such that light incident in a first direction (L(X)) enters the multi-pixel-microlens 410 from one side of the line 430L and is collected in a first diode 420D. Light incident in a second direction (R(X)) enters the multi-pixel-microlens 410 from the other side of the line 430R and is collected in a second diode 420F. Accordingly, data received from diodes 420D, 420F can be used for phase detection.

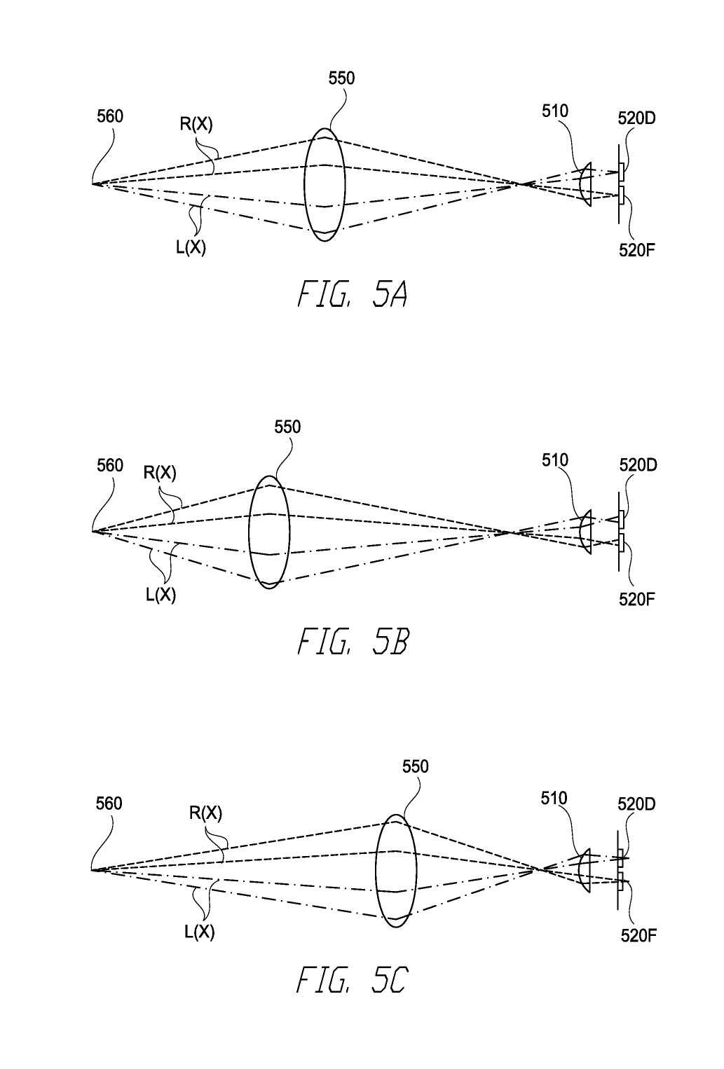

FIGS. 5A-5C depict example ray traces of light traveling through a main lens 550 then through a multi-pixel-microlens 510 before falling incident on a pair of phase detection diodes 520D, 520F. Multi-pixel-microlens 510 and diodes 520D and 520F may be substantially similar to multi-pixel-microlens 410 and diodes 420D and 420F of FIG. 4. It will be appreciated that the dimensions of the main lens 550 and the multi-pixel-microlens 510 are not shown to scale. The diameter of the multi-pixel-microlens 510 can be approximately equal to the distance spanning two adjacent diodes of an image sensor, while the diameter of the main lens 550 can be equal to or greater than the width (the distance along a row or column of diodes) of the image sensor.

Specifically, FIG. 5A depicts an example ray trace of an in-focus condition, FIG. 5B depicts an example ray trace of a front-focus condition, and FIG. 5C depicts an example ray trace of a back-focus condition. Light travels from a point 560 in a target scene, travels through lens 550 for focusing the target scene onto an image sensor including the phase detection diodes 520D and 520F, and passes through the multi-pixel-microlens 510 before falling incident onto the phase detection diodes 520D and 520F. As illustrated, diode 520D receives light from a left direction L(X) of the main lens 550 and diode 520F receives light from a right direction R(X) of the main lens 550. In some embodiments light from the left direction L(X) can be light from a left half (depicted as the lower half in the illustration of FIGS. 5A-5C) of the main lens 550 and light from the right direction R(X) can be light from a right half (depicted as the upper half in the illustration of FIGS. 5A-5C) of the main lens 550. Accordingly, a number of phase detection diodes interleaved with imaging diodes across the image sensor can be used to extract left and right images that are offset from a center image captured by the imaging diodes. Rather than right and left, other embodiments can use up and down images, diagonal images, or a combination of left/right, up/down, and diagonal images for calculating autofocus adjustments.

When the image is in focus, the left rays L(X) and right rays R(X) converge at the plane of the phase detection diodes 520D and 520F. As illustrated in FIGS. 5B and 5C, in front and back defocus positions the rays converge before and after the plane of the diodes, respectively. As described above, signals from the phase detection diodes can be used to generate left and right images that are offset from the center image in front or back defocus positions, and the offset amount can be used to determine an autofocus adjustment for the main lens 550. The main lens 550 can be moved forward (toward the image sensor) or backward (away from the image sensor) depending on whether the focal point is in front of the subject (closer to the image sensor), or behind the subject (farther away from the image sensor). Because the autofocus process can determine both the direction and amount of movement for main lens 550, phase-difference autofocus can focus very quickly.

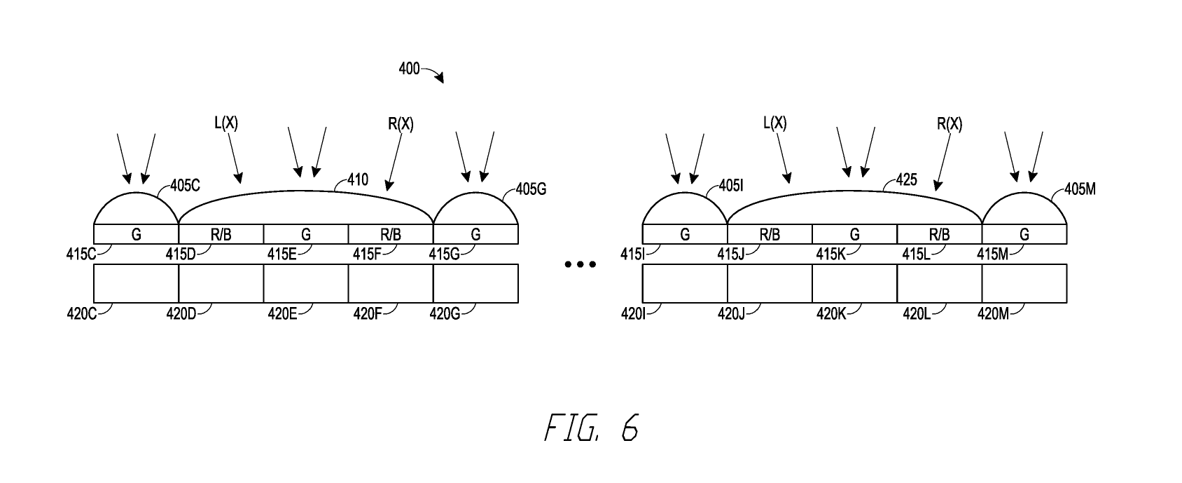

FIG. 6 depicts a schematic example of phase detection using the example multi-pixel-microlens 410 of FIG. 4. FIG. 6 illustrates that the image sensor may include other phase detection locations, as shown by having additional single-diode microlenses 405I, 405M, additional multi-pixel-microlens 425, additional color filters 415I-M, and additional diodes 420I-M. Accordingly, the image sensor may comprise an array of microlenses where a first subset of the microlenses in the array include single-diode microlenses (e.g., single-diode microlenses 405C, 405G, 405I, 405M, etc.) and a second subset of the microlenses in the array include multi-pixel-microlenses (e.g., multi-pixel-microlenses 410, 425, etc.). While an illustrative number of single- and multi-pixel-microlenses are illustrated here, it should be understood that each subset of microlenses may comprise any number of single-diode microlenses or multi-pixel-microlenses based on the specifications of the image sensor.

Incoming light is represented by arrows, and is understood to be incident from a target scene. As used herein, “target scene” refers to any scene or area having objects reflecting or emitting light that is sensed by the image sensor or any other phenomena viewable by the image sensor. Light from the target scene propagates toward diodes 420C-420G and 420I-420M, and is incident on the diodes after first passing through the microlenses and then the color filter array.

To perform phase detection, the imaging system can save two images containing only values received from the phase detection diodes 420D, 420F, 420J, and 420L. For example, left side data may be used to save an image based on light received from direction L(X) and right side data may be used to save an image based on light received from direction R(X). Diode 420D receives light entering multi-pixel-microlens 410 from the left side direction and diode 420F receives light entering multi-pixel-microlens 410 from the right side direction. Similarly, diode 420J receives light entering multi-pixel-microlens 425 from the left side direction (L(X)) and diode 420L receives light entering multi-pixel-microlens 425 from the right side direction (R(X)). Any number of multi-pixel-microlenses can be disposed over an image sensor ranging from one to all of the microlenses of the sensor, based on balancing the considerations of more multi-pixel-microlenses providing more reliable phase detection autofocus data but requiring greater amounts of computation for pixel value calculations and also increasing the likelihood of artifacts in a final image.

Focus can be calculated by applying a cross-correlation function to the data representing the left and right images. If the distance between the two images is narrower than the corresponding distance in an in-focus condition, the autofocus system determines that the focal point is in front of the subject. If the distance is wider than the reference value, the system determines that the focal point is behind the subject. For example, when in focus, the two images correlate without an offset or minimal offset (e.g., an offset of less than 1 pixel), and when not in focus the offset is noticeable (e.g., several pixels in the negative or positive, depending if it is behind or in front of the focus point). The autofocus system can compute how much the lens position (or sensor position, in embodiments having a movable sensor) should be moved and in which direction and provide this information to the lens actuator to move the lens accordingly, providing for fast focusing. The above-described process can be performed by the image signal processor 1020 of FIG. 10 in some examples.

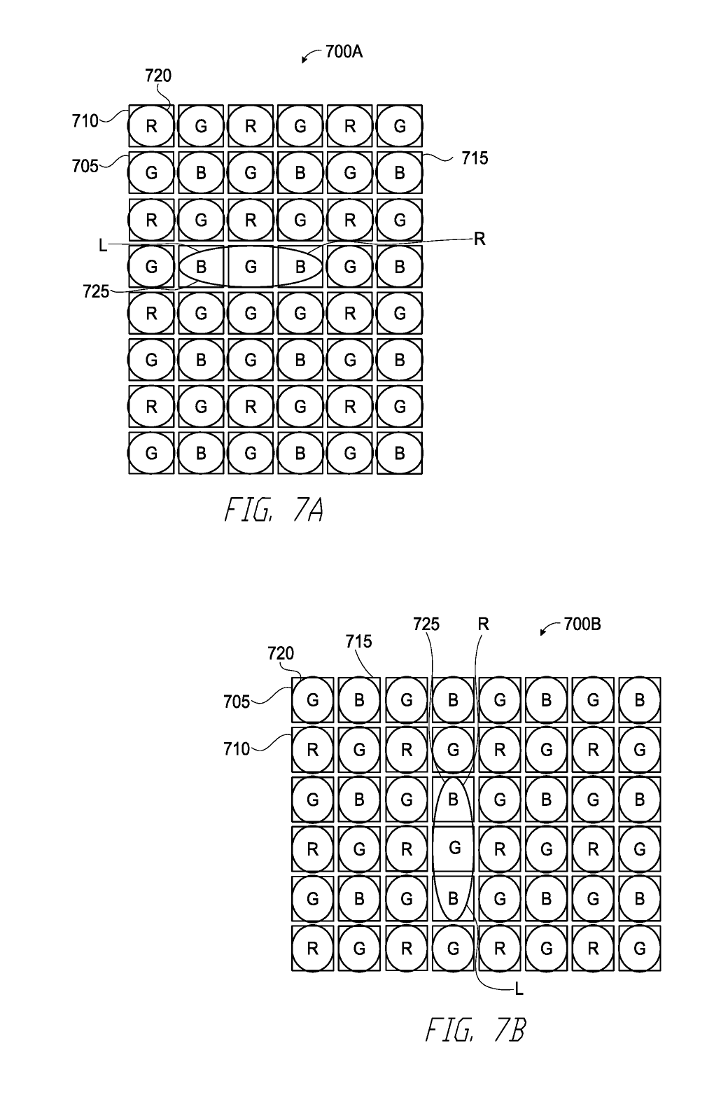

FIGS. 7A and 7B depict example arrangements of color filters 705, 710, and 715, single-diode microlenses 720, and a multi-pixel-microlens 725 for phase detection image sensors 700A and 700B as described herein. In some embodiments, the phase detection image sensors 700A and 700B may comprise one or more example sensor portions 400 described in connection with FIGS. 4 and/or 6. Only a portion of each image sensor 700A and 700B is illustrated, and this portion can be repeated across the sensor array or interspersed in selected phase detection locations in the Bayer pattern depending on the desired balance between number of phase detection pixels and image quality.

As illustrated, a number of green color filters 705, red color filters 710, and blue color filters 715 are arranged in a Bayer pattern. Each color filter is called out once using reference numbers 705, 710, or 715 and shown using G, R, or B for simplicity of the illustration. FIG. 7A depicts the multi-pixel-microlenses 725 disposed over three adjacent pixels in a row including two blue color filters 715 and a green color filter 705 therebetween, and corresponding diodes. The three adjacent pixels may be disposed in a linear arrangement, e.g., in a row or column. FIG. 7B depicts the multi-pixel-microlenses 725 disposed over three adjacent pixels in a column. In some embodiments, a red color filter 710 may be disposed in place of the blue color filter 715.

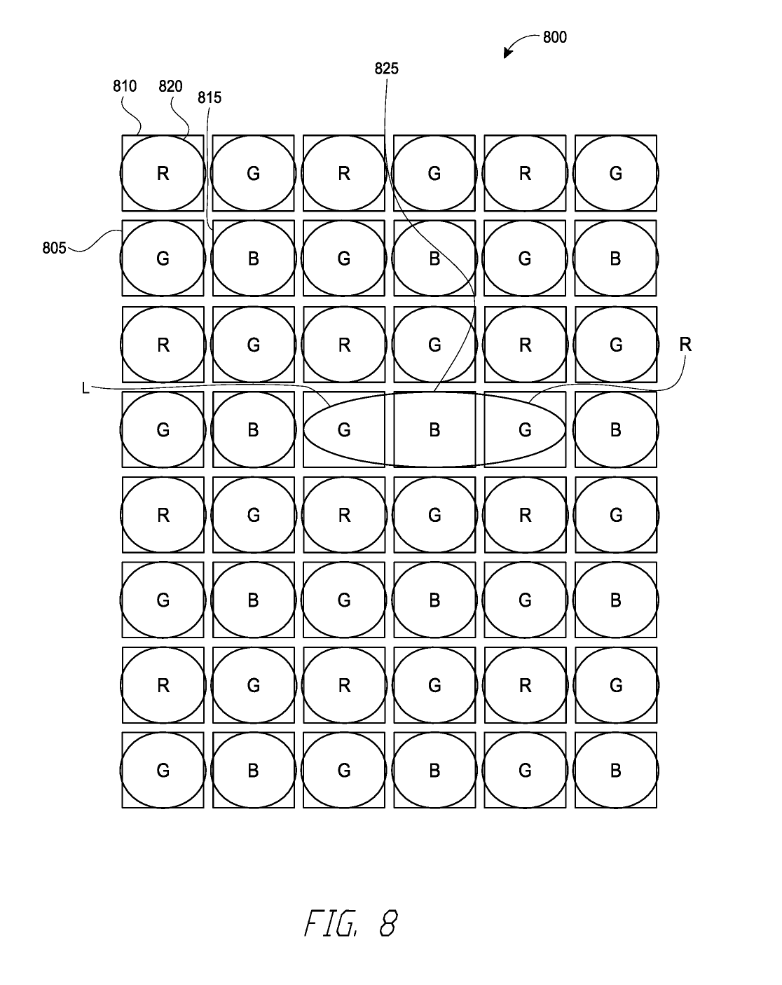

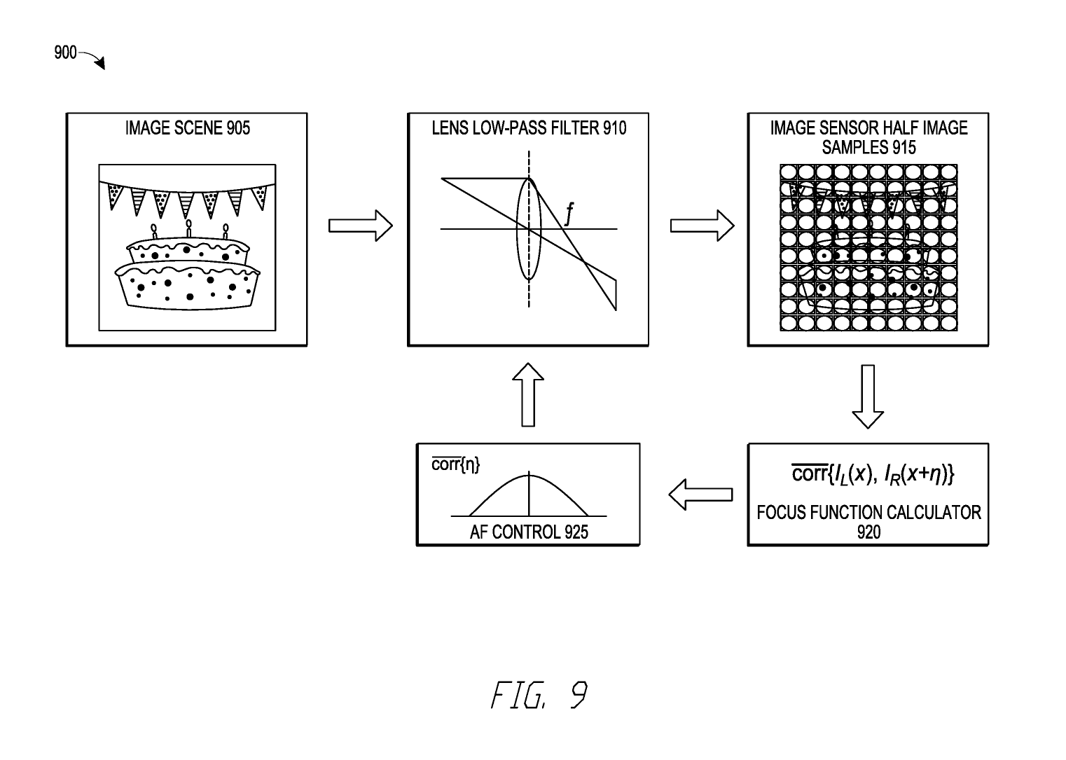

FIG. 8 depicts another example arrangement 800 of green color filters 805, red color filters 810, blue color filters 815, single-diode microlenses 820, and a multi-pixel-microlens 825 for a phase detection image sensor as described herein. The arrangement 800 is substantially similar to arrangement image sensor 700A of FIG. 7A. However, here the multi-pixel-microlens 825 is disposed over two green color filters 805 and a blue color filter 715 therebetween, and corresponding diodes. It should be understood that a similar arrangement is possible where the multi-pixel-microlens 825 is disposed over a red color filter 810 and corresponding diode, opposed to the blue color filter 815.

In some embodiments, the determination to dispose the multi-pixel-microlens over pairs of red, blue, or even green color filters may be based on the desired ability of the image signal processing hardware (e.g., as described in connection to FIG. 10 below) to compensate for defects due, in part, to the multi-pixel-microlens. For example, where the designed image signal processing hardware is designed to have good green correction and poor blue correct, the arrangement 800 of FIG. 8 may be preferred. In another embodiment, if the designed image signal processing hardware has very good red or blue correction and poor green correct, the arrangement 700A or 700B of FIGS. 7A and 7B, respectively, may be preferred. If the designed image signal processing hardware has very good correction in all colors, any arrangement 700A, 700B, or 800 may be used.

### Overview of Example Phase Detection Autofocus Process

FIG. 9 depicts a high-level overview of an example phase detection autofocus process 900 using a sensor having any one of the multi-pixel-microlenses described herein, for example, in connection to FIGS. 3A-4 and 6-8. In one embodiment, the process 900 can be performed on-sensor. In other implementations, the process 900 can involve one or more processors, for example image signal processor 1020 of FIG. 10.

Light representing the target scene 905 is passed through the lens assembly 910 and received by the image sensor, where half-image samples 915 are produced using the multi-pixel-microlenses described above. Because the dimensions of the lens assembly 910 and sensor are larger than the length of the light-wave, the lens assembly 910 can be modeled as a linear low-pass filter with a symmetric impulse response. The impulse response (also referred to as the point spread function) of the lens assembly 910 may be of a rectangular shape with a width parameter proportional to the distance between the sensor and the image plane. The scene is “in focus” when the sensor is in the image plane, that is, in the plane where all rays from a single point at the scene converge into a single point. As shown in FIG. 9, the half-image samples 915 can save two images containing only information from the phase detection pixels. The half-images can be considered as convolutions of the target scene with left and right (or, in other examples, up and down) impulse responses of the lens assembly 910.

A focus function calculator 920 applies a cross-correlation function to the partial images to determine disparity. The cross-correlation function of the left and right impulse responses of the lens assembly 910 can be approximately symmetric and unimodal. However, due to the nature of the target scene 905, the cross-correlation function as applied to the left and right captured images may have one or more false local maxima. Various approaches can be used to identify the true maximum of the cross-correlation function. The result of the cross-correlation function is provided as feedback to the autofocus control 925, which can be used to drive a lens actuator to move the primary focusing lens assembly 910 to a desired focus position. Other embodiments may use a stationary primary focusing lens assembly and move the image sensor to the desired focus position. Accordingly, in the phase detection autofocus process 900, focusing may be equivalent to searching for the cross-correlation function maximum. This is a fast process that can be done quickly enough to provide focus adjustment for each frame at typical frame rates, for example at 30 frames per second, and thus can be used to provide smooth autofocusing for video capture. Some implementations combine phase detection autofocus with contrast-based autofocus techniques, for example, to increase accuracy.

When the primary focusing lens assembly 910 and/or image sensor are in the desired focus position, the image sensor can capture in-focus imaging pixel information and phase detection pixel information. The imaging pixel values and determined phase detection pixel values can be output for preforming autofocusing operations or capturing an image. Optionally, the imaging pixel values and determined phase detection pixel values can also be output for preforming demosaicking, calculating, and interpolating color values for the phase detection pixels, and other image processing techniques to generate a final image of the target scene.

### Overview of Example Phase Detection Autofocus Process

FIG. 10 illustrates a high-level schematic block diagram of an embodiment of an image capture device 1000 having multispectral iris authentication capabilities, the image capture device 1000 comprising a set of components including an image signal processor 1020 linked to a phase detection autofocus camera 1015. The image signal processor 1020 is also in communication with a working memory 1005, memory 1030, and device processor 1050, which in turn is in communication with storage module 1010 and an optional electronic display 1025.

Image capture device 1000 may be a portable personal computing device such as a mobile phone, digital camera, tablet computer, personal digital assistant, or the like. There are many portable computing devices in which using the phase detection autofocus techniques as described herein would provide advantages. Image capture device 1000 may also be a stationary computing device or any device in which the multispectral iris verification techniques would be advantageous. A plurality of applications may be available to the user on image capture device 1000. These applications may include traditional photographic and video applications as well as data storage applications and network applications.

The image capture device 1000 includes phase detection autofocus camera 1015 for capturing external images. The phase detection autofocus camera 1015 can include an image sensor having multi-pixel-microlenses and color filters arranged according to the embodiments described above, for example, in connection to FIGS. 3A-4 and 6-8. The phase detection autofocus camera 1015 can also have a primary focusing mechanism positionable based, at least partly, on data received from the image signal processor 1020 to produce an in-focus image of the target scene. In some embodiments, the primary focusing mechanism can be a movable lens assembly positioned to pass light from the target scene to the sensor. In some embodiments, the primary focusing mechanism can be a mechanism for moving the sensor.

The sensor of the phase detection autofocus camera 1015 can have different processing functionalities in different implementations. In one implementation, the sensor may not process any data, and the image signal processor 1020 may perform all needed data processing. In another implementation, the sensor may be capable of extracting phase detection pixels, for example into a separate Mobile Industry Processor Interface (MIPI) channel. An imaging apparatus as described herein may include an image sensor capable of performing all phase detection calculations or an image sensor capable of performing some or no processing together with an image signal processor 1020 and/or device processor 1050. While not necessary to achieve accurate phase detection and image values, in some embodiments, the sensor may optionally be capable of interpolating missing pixel values, for example, in a RAW channel The sensor may optionally be capable of interpolating missing pixel values, for example, in a normal channel, and may be able to process the whole phase detection calculation internally (on-sensor). For example, the sensor may include analog circuitry for performing sums, subtractions, and/or comparisons of values received from diodes.

The image signal processor 1020 may be configured to perform various processing operations on received image data in order to execute phase detection autofocus and image processing techniques. Image signal processor 1020 may be a general purpose processing unit or a processor specially designed for imaging applications. Examples of image processing operations include demosaicking, white balance, cross talk reduction, cropping, scaling (e.g., to a different resolution), image stitching, image format conversion, color interpolation, color processing, image filtering (e.g., spatial image filtering), lens artifact or defect correction, etc. The image signal processor 1020 can also control image capture parameters such as autofocus and auto-exposure. Image signal processor 1020 may, in some embodiments, comprise a plurality of processors. Image signal processor 1020 may be one or more dedicated image signal processors (ISPs) or a software implementation of a processor. In some embodiments, the image signal processor 1020 may be optional for phase detection operations, as some or all of the phase detection operations can be performed on the image sensor.

As shown, the image signal processor 1020 is connected to a memory 1030 and a working memory 1005. In the illustrated embodiment, the memory 1030 stores capture control module 1035, phase detection autofocus module 1040, and operating system module 1045. The modules of the memory 1030 include instructions that configure the image signal processor 1020 of device processor 1050 to perform various image processing and device management tasks. Working memory 1005 may be used by image signal processor 1020 to store a working set of processor instructions contained in the modules of memory. Alternatively, working memory 1005 may also be used by image signal processor 1020 to store dynamic data created during the operation of image capture device 1000.

As mentioned above, the image signal processor 1020 is configured by several modules stored in the memories. The capture control module 1035 may include instructions that configure the image signal processor 1020 to adjust the focus position of phase detection autofocus camera 1015, for example, in response to instructions generated during a phase detection autofocus technique. Capture control module 1035 may further include instructions that control the overall image capture functions of the image capture device 1000. For example, capture control module 1035 may include instructions that call subroutines to configure the image signal processor 1020 to capture multispectral image data including one or more frames of a target scene using the phase detection autofocus camera 1015. In one embodiment, capture control module 1035 may call the phase detection autofocus module 1040 to calculate lens or sensor movement needed to achieve a desired autofocus position and output the needed movement to the imaging processor 1020. Optionally, in some embodiments, the capture control module 1035 may call the phase detection autofocus module 1040 to interpolate color values for pixels positioned beneath multi-pixel-microlenses.

Accordingly, phase detection autofocus module 1040 can store instructions for executing phase detection autofocus. In some embodiments, the phase detection autofocus module 1040 can also store instructions for calculating color values for phase detection pixels and for image generation based on phase detection pixel values and imaging pixel values.

Operating system module 1045 configures the image signal processor 1020 to manage the working memory 1005 and the processing resources of image capture device 1000. For example, operating system module 1045 may include device drivers to manage hardware resources such as the phase detection autofocus camera 1015. Therefore, in some embodiments, instructions contained in the image processing modules discussed above may not interact with these hardware resources directly, but instead interact through standard subroutines or APIs located in operating system module 1045. Instructions within operating system module 1045 may then interact directly with these hardware components. Operating system module 1045 may further configure the image signal processor 1020 to share information with device processor 1050.

Device processor 1050 may be configured to control the display 1025 to display the captured image, or a preview of the captured image, to a user. The display 1025 may be external to the imaging device 1000 or may be part of the imaging device 1000. The display 1025 may also be configured to provide a view finder displaying a preview image for a use prior to capturing an image, for example to assist the user in aligning the image sensor field of view with the user's eye, or may be configured to display a captured image stored in memory or recently captured by the user. The display 1025 may comprise an LCD, LED, or OLED screen, and may implement touch sensitive technologies.

Device processor 1050 may write data to storage module 1010, for example data representing captured images and data generated during phase detection and/or pixel value calculation. While storage module 1010 is represented schematically as a traditional disk device, storage module 1010 may be configured as any storage media device. For example, the storage module 1010 may include a disk drive, such as an optical disk drive or magneto-optical disk drive, or a solid state memory such as a FLASH memory, RAM, ROM, and/or EEPROM. The storage module 1010 can also include multiple memory units, and any one of the memory units may be configured to be within the image capture device 1000, or may be external to the image capture device 1000. For example, the storage module 1010 may include a ROM memory containing system program instructions stored within the image capture device 1000. The storage module 1010 may also include memory cards or high speed memories configured to store captured images which may be removable from the camera. The storage module 1010 can also be external to image capture device 1000, and in one example image capture device 1000 may wirelessly transmit data to the storage module 1010, for example over a network connection. In such embodiments, storage module 1010 may be a server or other remote computing device.

Although FIG. 10 depicts an image capture device 1000 having separate components to include a processor, imaging sensor, and memory, it is noted that these separate components may be combined in a variety of ways to achieve particular design objectives. For example, in an alternative embodiment, the memory components may be combined with processor components, for example to save cost and/or to improve performance.

Additionally, although FIG. 10 illustrates two memory components, including memory 1030 comprising several modules and a separate memory component comprising a working memory 1005, other implementations may include different memory architectures. For example, a design may utilize ROM or static RAM memory for the storage of processor instructions implementing the modules contained in memory 1030. The processor instructions may be loaded into RAM to facilitate execution by the image signal processor 1020. For example, working memory 1005 may comprise RAM memory, with instructions loaded into working memory 1005 before execution by the image signal processor 1020.

### Example Method of Constructing a Final Image

FIG. 11 illustrates a flowchart depicting a method for constructing a final image, in accordance with an exemplary implementation. As described in connection to FIG. 10, the image capture device 1000 may include an image signal processor 1020 linked to a phase detection autofocus camera 1015 for capturing images using an image sensor having multi-pixel-microlenses and color filters arranged according to the embodiments described above, for example, in connection to FIGS. 3A-4 and 6-8. Although the process in FIG. 11 is illustrated in a particular order, in certain embodiments the blocks herein may be performed in a different order, or omitted, and additional blocks can be added. The process of the illustrated embodiment may be implemented in any image capture device 1000 of FIG. 10 in order to construct a final image.

At block 1110, the image capture device receives image data from a plurality of diodes associated with a plurality of color filters arranged in a pattern as described in the various embodiments throughout this application. In some embodiments, the image data may comprise imaging pixel values and phase detection pixel values. For example, the imaging pixel values may be received from a first subset of the plurality of diodes (e.g., diodes 420E and 420K of FIG. 6) associated with a first subset of the plurality of color filters (e.g., color filters 415E and 415K of FIG. 6) and a plurality of multi-pixel-microlenses (e.g., multi-pixel-microlenses 410 and 425 of FIG. 6). The imaging pixel values may also be received from a second subset of the plurality of diodes (e.g., diodes 420C, 420G, 420I, and 420M of FIG. 6 and other diodes of the image sensor as described in FIGS. 7A, 7B, and 8) associated with a second subset of the plurality of color filters (e.g., color filters 415C, 415G, 415I, and 415M of FIG. 6 and other color filters of the image sensor as described in FIGS. 7A, 7B, and 8) and a plurality of single-diode microlenses (e.g., single-diode microlenses 405C, 405G, 405I and 405M of FIG. 6 other microlenses of the image sensor as described in FIGS. 7A, 7B, and 8). The phase detection pixel values may be received from a third subset of the plurality of diodes (e.g., diodes 420D, 420F, 420J and 420L of FIG. 6) associated with a third subset of the plurality of color filters (e.g., color filters 415D, 415F, 415J, and 415L of FIG. 6) and the plurality of multi-pixel-microlenses (e.g., multi-pixel-microlenses 410 and 425 of FIG. 6). In some embodiments, the third subset of the plurality of diodes may be arranged in a plurality of groups of adjacent diodes (e.g., diodes 420D-F and 420J-L of FIG. 6) comprising at least one diode (e.g., diode 420E or 420K) of the first subset of the plurality of diodes and at least two diodes (e.g., diodes 420D and 420F or 420J and 420L) of the third subset of the plurality of diodes. Each group of the plurality of groups may receive light from a corresponding a multi-pixel-microlens (e.g., multi-pixel-microlens 410 and 425) formed such that light incident in a first direction (L(X)) is collected in a first diode (e.g., diode 420D or 420J) of the third subset of the plurality of diodes and light incident in a second direction (R(X)) is collected in a second diode (e.g., diode 420F or 420L) of the third subset of the plurality of diodes.

At block 1120, the image display device 1000 may calculate a disparity based on the light collected in the first direction (L(X)) and second direction (R(X)) in block 1110. In some embodiments, at block 1120 the image display device may generate focus instructions based on the received image data, for example, based on the light collected in the first direction (L(X)) and second direction (R(X)) at block 1110. In some embodiments, the focus instructions may be based on the calculated disparity between the light collected in the first direction (L(X)) and second direction (R(X)) in block 1110. In some embodiments, the focus instructions may comprise a distance and direction for moving the movable lens assembly to a desired focus position, as described in connection to FIGS. 5A-5C.

At block 1130, the image display device 1000 may construct an image based on the received image data. For example, the image display device 1000 may construct an image based at least on the plurality of pixel values of block 1110 and the focus instructions of block 1120.

### Implementing Systems and Terminology

Implementations disclosed herein provide systems, methods and apparatus for mask-less phase detection autofocus. It is noted that these embodiments may be implemented in hardware, software, firmware, or any combination thereof.

In some embodiments, the circuits, processes, and systems discussed above may be utilized in a wireless communication device. The wireless communication device may be a kind of electronic device used to wirelessly communicate with other electronic devices. Examples of wireless communication devices include cellular telephones, smart phones, Personal Digital Assistants (PDAs), e-readers, gaming systems, music players, netbooks, wireless modems, laptop computers, tablet devices, etc.

The wireless communication device may include one or more image sensors, one or more image signal processors, and a memory including instructions or modules for carrying out the process discussed above. The device may also have data, a processor loading instructions and/or data from memory, one or more communication interfaces, one or more input devices, one or more output devices such as a display device and a power source/interface. The wireless communication device may additionally include a transmitter and a receiver. The transmitter and receiver may be jointly referred to as a transceiver. The transceiver may be coupled to one or more antennas for transmitting and/or receiving wireless signals.

The wireless communication device may wirelessly connect to another electronic device (e.g., base station). A wireless communication device may alternatively be referred to as a mobile device, a mobile station, a subscriber station, a user equipment (UE), a remote station, an access terminal, a mobile terminal, a terminal, a user terminal, a subscriber unit, etc. Examples of wireless communication devices include laptop or desktop computers, cellular phones, smart phones, wireless modems, e-readers, tablet devices, gaming systems, etc. Wireless communication devices may operate in accordance with one or more industry standards such as the 3rd Generation Partnership Project (3GPP). Thus, the general term “wireless communication device” may include wireless communication devices described with varying nomenclatures according to industry standards (e.g., access terminal, user equipment (UE), remote terminal, etc.).

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed, or computed by the computing device or processor. As used herein, the term “code” may refer to software, instructions, code, or data that is/are executable by a computing device or processor.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It should be noted that the terms “couple,” “coupling,” “coupled” or other variations of the word couple as used herein may indicate either an indirect connection or a direct connection. For example, if a first component is “coupled” to a second component, the first component may be either indirectly connected to the second component or directly connected to the second component. As used herein, the term “plurality” denotes two or more. For example, a plurality of components indicates two or more components.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

In the foregoing description, specific details are given to provide a thorough understanding of the examples. However, it is noted that the examples may be practiced without these specific details. For example, electrical components/devices may be shown in block diagrams in order not to obscure the examples in unnecessary detail. In other instances, such components, other structures, and techniques may be shown in detail to further explain the examples. Thus, the present invention is not intended to be limited to the implementations shown herein but is to be accorded the widest scope consistent with the principles and novel features disclosed herein.

1. An image capture device, comprising:
an image sensor;
a plurality of diodes configured to sense light from a target scene;
a color filter array arranged in a pattern, each color filter positioned within proximity of one of the plurality of diodes and configured to pass one or more wavelengths of light to one of the plurality of diodes;
a plurality of single-diode microlenses each positioned within proximity of one of the plurality of color filters;
a plurality of multi-pixel-microlenses, each multi-pixel-microlens positioned within proximity of at least three adjacent color filters of the plurality of color filters, two of the at least three adjacent color filters configured to pass the same wavelengths of light to a first and second diode, one of the at least three adjacent color filters disposed between the two of the at least three adjacent color filters and configured to pass different wavelengths of light to a third diode positioned between the first and second diodes, wherein light incident on a multi-pixel-microlens in a first direction is collected in the first diode and light incident on the multi-pixel-microlens in a second direction is collected in the second diode; and
an image signal processor configured to perform phase detection autofocus based on values received from the first and second diodes, wherein each of the first and the second diodes is adjacent to the third diode, and wherein the values received from the first diode and the second diode are based on the light incident on the multi-pixel microlens in the first direction and the second direction respectively when performing the phase detection autofocus for both in-focus and out of focus conditions.

2. The image capture device of claim 1, wherein, for each of the plurality of multi-pixel-microlenses, the one of the at least three adjacent color filters is configured to pass wavelengths of light corresponding to green light.

3. The image capture device of claim 1, wherein, for each of the plurality of multi-pixel-microlenses, the one of the at least three adjacent color filters is configured to pass wavelengths of light corresponding to at least one of blue or red light.

4. The image capture device of claim 1, wherein, for each of the plurality of multi-pixel-microlenses, the two of the at least three adjacent color filters are configured to pass wavelengths of light corresponding to blue or red light.

5. The image capture device of claim 1, wherein, for each of the plurality of multi-pixel-microlenses, the two of the at least three adjacent color filters are configured to pass wavelengths of light corresponding to green.

6. The image sensor of claim 1, wherein the plurality of diodes comprise an array of a plurality of photodiodes formed in a semiconductor substrate.

7. The image sensor of claim 6, wherein each of the plurality of photodiodes receives light from at least one of the plurality of single-diode microlenses and the multi-pixel-microlens.

8. The image capture device of claim 1, wherein the plurality of diodes and the plurality of color filters are arranged in a repeating pattern having the plurality of single-diode microlenses and the plurality of multi-pixel-microlenses each located at one of a plurality of autofocus points in the repeating pattern.

9. The image capture device of claim 1, wherein the plurality of color filters are arranged in a Bayer pattern.

10. The image capture device of claim 1, wherein, to perform phase detection autofocus, the image signal processor is further configured to:
receive, from the first diode, first image data representing light incident on the image sensor in the first direction;
receive, from the second diode, second image data representing light incident on the image sensor in the second direction;
calculate a disparity between the first image data and the second image data; and
generate focus instructions based on the disparity.

11. The image capture device of claim 10, further comprising a movable lens assembly positioned within proximity to the image sensor.

12. The image capture device of claim 11, wherein the focus instructions comprise a distance and direction for moving the movable lens assembly to a desired focus position.

13. The image capture device of claim 12, wherein the image signal processor is further configured to generate instructions that cause the image sensor to capture image data with the movable lens assembly positioned in the desired focus position and, based at least partly on the first and second image data, construct a final image of the target scene.

14. The image capture device of claim 1, wherein the image signal processor is further configured to:
receive image data from the plurality of diodes, the image data comprising:
a plurality of phase detection pixel values from a first subset of the plurality of diodes comprising the first and second diodes associated with the two of the at least three adjacent color filters, and
a plurality of imaging pixel values from a second subset of the plurality of diodes associated with the plurality of color filters, wherein the second subset of the plurality of diodes comprises the first, second, and third diodes associated with the plurality of multi-pixel-microlenses;
calculate a disparity based on the light collected in the first direction and light collected in the second direction to generate focus instructions; and
construct an image based at least partly on the plurality of imaging pixel values and focus instructions.

15. The image signal processor of claim 14, wherein an imaging pixel value of the plurality of imaging pixel values received from the first and second diodes associated with a multi-pixel-microlens has a value that is substantially similar to another imaging pixel value received from a diode positioned under a single-diode microlens and associated with a color filter configured to pass the same wavelengths of light as the color filter associated with the first and second diodes.

16. An image sensor comprising:
a plurality of diodes configured to sense light from a target scene;
a plurality of single-diode microlenses each positioned adjacent to one of the plurality of diodes;
a plurality of multi-pixel-microlenses, each multi-pixel-microlens of the plurality of multi-pixel-microlenses positioned adjacent to at least three linearly adjacent diodes of the plurality of diodes, the at least three diodes of the plurality of diodes comprising a first and second diode disposed at the respective ends of the multi-pixel-microlens and a third diode positioned between the first and second diode, wherein light incident on a multi-pixel microlens in a first direction is collected in the first diode and light incident on the multi-pixel microlens in a second direction is collected in the second diode; and
an image signal processor configured to receive values representing the light incident on the first and second diodes, wherein each of the first and the second diodes is adjacent to the third diode and perform phase detection autofocus using the received values wherein the values received from the first diode and the second diode are based on the light incident on the multi-pixel microlens in the first direction and the second direction respectively when performing the phase detection autofocus for both in-focus and out of focus conditions.

17. The image sensor of claim 16, further comprising a plurality of color filters disposed within proximity of the plurality of diodes in a pattern, each color filter positioned within proximity of one of the plurality of diodes and configured to pass one or more wavelengths of light to one of the plurality of diodes.

18. The image sensor of claim 16, wherein the color filters positioned within proximity of the first and second diodes are configured to pass the same wavelengths of light.

19. The image sensor of claim 16, wherein the color filter positioned within proximity of the third diode configured to pass wavelengths of light that are different than the wavelengths of light passed by the color filters positioned within proximity of the first or second diodes.

20. The image sensor of claim 17, wherein the plurality of diodes and the plurality of color filters are arranged in a repeating pattern having the plurality of single-diode microlenses and the plurality of multi-pixel-microlenses each located at one of a plurality of autofocus points in the repeating pattern.

21. The image sensor of claim 17, wherein the color filters of the plurality of color filters are arranged in a Bayer pattern.

22. The image sensor of claim 16, wherein, to perform phase detection autofocus, the image signal processor is further configured to:
receive, from the first diode, first image data representing light incident on the image sensor in the first direction;
receive, from the second diode, second image data representing light incident on the image sensor in the second direction;
calculate a disparity between the first image data and the second image data; and
generate focus instructions based on the disparity.

23. A method for constructing a final image, the method comprising:
receiving image data from a plurality of diodes associated with a plurality of color filters arranged in a pattern, the image data comprising:
a plurality of imaging pixel values from:
a first subset of the plurality of diodes associated with a first subset of the plurality of color filters and a plurality of multi-pixel-microlenses, and
a second subset of the plurality of diodes associated with a second subset of the plurality of color filters and a plurality of single-diode microlenses, and
a plurality of phase detection pixel values from a third subset of the plurality of diodes associated with a third subset of the plurality of color filters and the plurality of multi-pixel-microlenses, the third subset of the plurality of diodes arranged in a plurality of groups of adjacent diodes comprising at least one diode of the first subset of the plurality of diodes and at least two diodes of the third subset of the plurality of diodes, each group of the plurality of groups receiving light from a corresponding multi-pixel-microlens formed such that light incident in a first direction is collected in a first diode of the third subset of the plurality of diodes and light incident in a second direction is collected in a second diode of the third subset of the plurality of diodes;
calculating a disparity based on the light collected in the first direction and light collected in the second direction to generate focus instructions, wherein values received from the first diode and the second diode are based on the light incident on the corresponding multi-pixel microlens in the first direction and the second direction respectively when generating the autofocus instructions for both in-focus and out of focus conditions; and
constructing an image based at least partly on the plurality of imaging pixel values and focus instructions.

24. The method of claim 23, wherein an imaging pixel value of the plurality of imaging pixel values received from the first subset of the plurality of diodes has a value that is substantially similar to another imaging pixel value received the second subset of the plurality of diodes.

25. The method of claim 23, wherein each color filter of the third subset of the plurality of color filters is configured to pass the same wavelengths of light to each diode of the third subset of the plurality of diodes.

26. The method of claim 23, wherein the first subset of the plurality of color filters are configured to pass wavelengths of light different than the wavelengths of light passed by the third subset of the plurality of color filters.

27. An image signal processor configured by instructions to execute a process for constructing a final image, the process comprising:
receiving image data from a plurality of diodes associated with a plurality of color filters arranged in a pattern, the image data comprising:
a plurality of imaging pixel values from:
a first subset of the plurality of diodes associated with a first subset of the plurality of color filters a plurality of multi-pixel-microlenses, and
a second subset of the plurality of diodes associated with a second subset of the plurality of color filters and a plurality of single-diode microlenses, and
a plurality of phase detection pixel values from a third subset of the plurality of diodes associated with a third subset of the plurality of color filters and the plurality of multi-pixel-microlenses, the third subset of the plurality of diodes arranged in a plurality of groups of adjacent diodes comprising at least one diode of the first subset of the plurality of diodes and at least two diodes of the third subset of the plurality of diodes, each group of the plurality of groups receiving light from a corresponding multi-pixel-microlens formed such that light incident in a first direction is collected in a first diode of the third subset of the plurality of diodes and light incident in a second direction is collected in a second diode of the third subset of the plurality of diodes;
calculating a disparity based on the light collected in the first direction and light collected in the second direction to generate focus instructions, wherein values received from the first diode and the second diode are based on the light incident on the corresponding multi-pixel-microlens in the first direction and the second direction respectively when generating the focus instructions for both in-focus and out of focus conditions; and
constructing an image based at least partly on the plurality of imaging pixel values and focus instructions.

28. The image signal processor of claim 27, wherein an imaging pixel value of the plurality of imaging pixel values received from the first subset of the plurality of diodes has a value that is substantially similar to another imaging pixel value received the second subset of the plurality of diodes.

29. The image signal processor of claim 27, wherein each color filter of the third subset of the plurality of color filters is configured to pass the same wavelengths of light to each diode of the third subset of the plurality of diodes.

30. The image signal processor of claim 27, wherein the first subset of the plurality of color filters are configured to pass wavelengths of light different than the wavelengths of light passed by the third subset of the plurality of color filters.
